(19) United States
(12) Patent Application Publication
(10) Pub. No.: US 2023/0187695 A1
(43) Pub. Date: Jun. 15, 2023

(54) ELECTROLYTE AND ELECTROCHEMICAL APPARATUS USING SAME

(71) Applicants: Ningde Amperex Technology Limited, Ningde, Fujian (CN); DONGGUAN AMPEREX TECHNOLOGY LIMITED, Dongguan City, Guangdong (CN)

(72) Inventors: Xiexue Peng, Ningde, Fujian (CN); Jianming Zheng, Ningde, Fujian (CN); Wenqiang Li, Ningde, Fujian (CN); Hui Chen, Ningde, Fujian (CN)

(21) Appl. No.: 17/281,167

(22) PCT Filed: May 22, 2020
(86) PCT No.: PCT/CN2020/091802

§ 371 Date: Jan. 5, 2023

(51) Int. Cl. H01M 10/0567; H01M 4/04; H01M 10/0525; H01M 10/0569; H01M 50/417; H01M 50/449

(52) U.S. Cl. CPC H01M 10/0567; H01M 4/0404; H01M 10/0525; H01M 10/0569; H01M 50/417; H01M 50/449; H01M 2300/0051

(57) ABSTRACT

An electrolyte including a compound

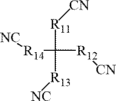

R₁₁ is a covalent bond, a substituted or unsubstituted C₁-C₂₀ alkylidene group, a substituted or unsubstituted C₂-C₂₀ alkenylene group, a substituted or unsubstituted C₂-C₂₀ alkynylene group, a substituted or unsubstituted C₆-C₂₀ arylene group, a substituted or unsubstituted C₃-C₂₀ heteroarylene group, a substituted or unsubstituted C₃-C₂₀ cycloalkylene group,

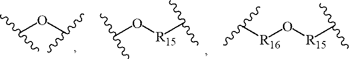

or a combination thereof. R₁₂, R₁₃, and R₁₄ are a substituted or unsubstituted C₁-C₂₀ alkylidene group, C₂-C₂₀ alkenylene group, C₂-C₂₀ alkynylene group, C₆-C₂₀ arylene group, C₃-C₂₀ heteroarylene group, or C₃-C₂₀ cycloalkylene group;

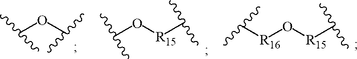

or a combination thereof. R₁₅ and R₁₆ are a C₁-C₂₀ alkylidene group, a substituted or unsubstituted C₂-C₂₀ alkenylene group, a substituted or unsubstituted C₂-C₂₀ alkynylene group, a substituted or unsubstituted C₆-C₂₀ arylene group, a substituted or unsubstituted C₃-C₂₀ heteroarylene group, or a substituted or unsubstituted C₃-C₂₀ cycloalkylene group.

### CROSS REFERENCE TO RELATED APPLICATIONS

The present application is a U.S. National Phase entry under 35 U.S.C. 371 of PCT international application: PCT/CN2020/091802, filed on 22 May 2020, the disclosure of which is hereby incorporated by reference in its entirety.

### TECHNICAL FIELD

This application relates to the technical field of electrochemical apparatuses, and more specifically, to an electrolyte and an electrochemical apparatus using the same.

### BACKGROUND

Electrochemical apparatuses, such as lithium-ion batteries, having advantages such as high energy density, low maintenance, relatively low self-discharge, long cycle life, no memory effect, high working voltage, and environmental friendliness, have received extensive attention of people and been widely used in the fields such as smart products (including mobile phones, laptops, cameras and other electronic products), electric power tools, and electric vehicles, and are gradually replacing the traditional nickel-cadmium or nickel-hydrogen batteries. However, with the rapid development of technologies and the diversity of market demands, people have also put forward more requirements for the power supply of electronic products, such as the requirements of being thinner and lighter, and having more diversified shapes, higher volumetric energy density and mass energy density, higher safety, and higher power.

In order to increase the energy density of batteries, the methods adopted are to increase the charging voltage/increase the capacity of active materials, but the like, which accelerates decomposition and gassing of electrolyte to cause battery swelling, resulting in safety issues such as battery explosion and fire. Therefore, it is necessary to increase the capacity of lithium-ion batteries while taking into account their safety issues (such as floating charge performances and hot-box performances).

### SUMMARY

Embodiments of this application provide an electrolyte and an electrochemical apparatus using the same, in an attempt to resolve at least one problem existing in the related fields at least to some extent. The embodiments of this application further provide the electrochemical apparatus using the electrolyte and an electronic apparatus.

According to one aspect of this application, an electrolyte is provided, and includes a compound of formula I:

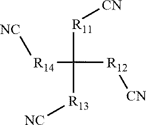

where Rn is selected from a covalent bond, a substituted or unsubstituted C₁-C₂₀ alkylidene group, a substituted or unsubstituted C₂-C₂₀ alkenylene group, a substituted or unsubstituted C₂-C₂₀ alkynylene group, a substituted or unsubstituted C₆-C₂₀ arylene group, a substituted or unsubstituted C₃-C₂₀ heteroarylene group, a substituted or unsubstituted C₃-C₂₀ cycloalkylene group,

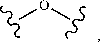

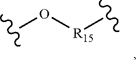

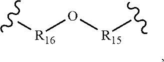

or a combination thereof;
where R₁₂, R₁₃, and R₁₄ are each independently selected from a substituted or unsubstituted C₁-C₂₀ alkylidene group, a substituted or unsubstituted C₂-C₂₀ alkenylene group, a substituted or unsubstituted C₂-C₂₀ alkynylene group, a substituted or unsubstituted C₆-C₂₀ arylene group, a substituted or unsubstituted C₃-C₂₀ heteroarylene group, a substituted or unsubstituted C₃-C₂₀ cycloalkylene group,

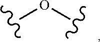

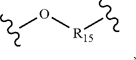

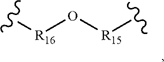

or a combination thereof;
where R₁₅ and R₁₆ are each independently selected from a C₁-C₂₀ alkylidene group, a substituted or unsubstituted C₂-C₂₀ alkenylene group, a substituted or unsubstituted C₂-C₂₀ alkynylene group, a substituted or unsubstituted C₆-C₂₀ arylene group, a substituted or unsubstituted C₃-C₂₀ heteroarylene group, or a substituted or unsubstituted C₃-C₂₀ cycloalkylene group;
where when the groups are substituted, substituents are each selected from halogen, a C₁-C₂₀ alkyl group, a C₃-C₂₀ cycloalkyl group, a C₂-C₂₀ alkenyl group, a C₆-C₂₀ aryl group, or a C₃-C₂₀ heteroaryl group; and
where the heteroatom is selected from one or more of O, S, N, and P.

In some embodiments, the compound of formula I includes at least one of the following compounds:

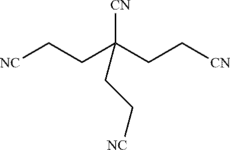

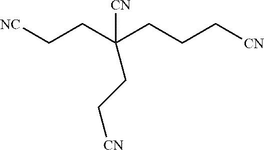

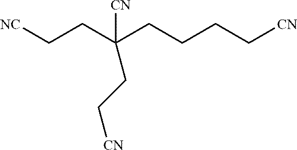

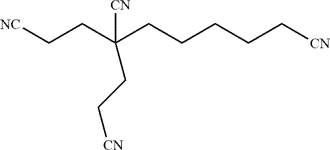

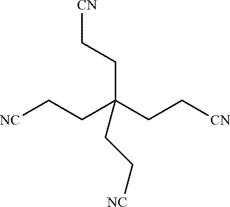

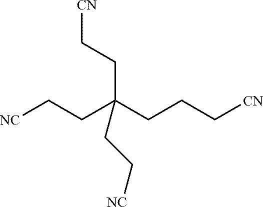

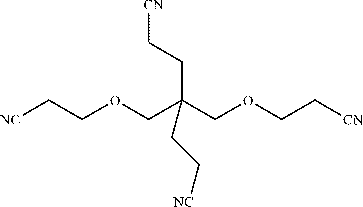

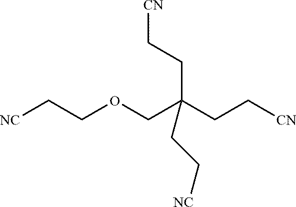

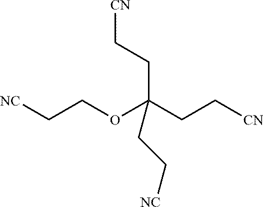

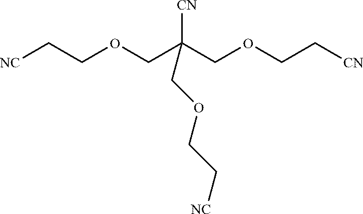

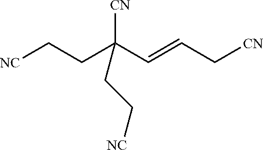

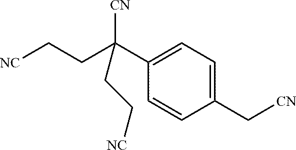

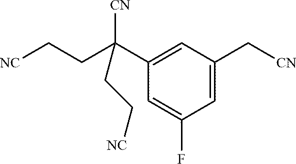

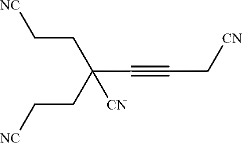

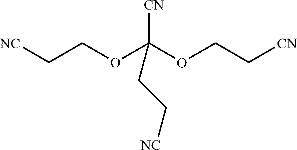

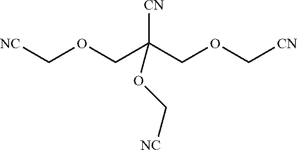

or

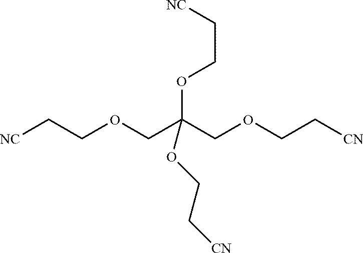

where based on a total weight of the electrolyte, a content of the compound of formula I is 0.01 wt% to 10 wt%.

In some embodiments, the electrolyte further includes a compound containing sulfur-oxygen double bonds, and the compound containing sulfur-oxygen double bonds includes a compound of formula (II-A), a compound of formula (II-B), or a combination thereof:

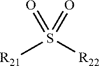

, and

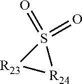

where R₂₁ and R₂₂ are each independently selected from a substituted or unsubstituted C₁-C₂₀ alkyl group, a substituted or unsubstituted C₂-C₂₀ alkenyl group, a substituted or unsubstituted C₂-C₂₀ alkynyl group, a substituted or unsubstituted C₆-C₂₀ aryl group, a substituted or unsubstituted C₃-C₂₀ heteroaryl group, a substituted or unsubstituted C₃-C₂₀ cycloalkyl group, —O—R₂₅, or —R₂₆—O—R₂₇;
where R₂₅ and R₂₇ are each independently selected from a substituted or unsubstituted C₁-C₂₀ alkyl group, a substituted or unsubstituted C₂-C₂₀ alkenyl group, a substituted or unsubstituted C₂-C₂₀ alkynyl group, a substituted or unsubstituted C₆-C₂₀ aryl group, a substituted or unsubstituted C₃-C₂₀ heteroaryl group, or a substituted or unsubstituted C₃-C₂₀ cycloalkyl group;
where R₂₆ is selected from a substituted or unsubstituted C₁-C₂₀ alkylidene group, a substituted or unsubstituted C₂-C₂₀ alkenylene group, a substituted or unsubstituted C₂-C₂₀ alkynylene group, a substituted or unsubstituted C₆-C₂₀ arylene group, a substituted or unsubstituted C₃-C₂₀ heteroarylene group, or a substituted or unsubstituted C₃-C₂₀ cycloalkylene group;
where R₂₃ and R₂₄ are each independently selected from a substituted or unsubstituted C₁-C₂₀ alkylidene group, a substituted or unsubstituted C₂-C₂₀ alkenylene group, a substituted or unsubstituted C₂-C₂₀ alkynylene group, a substituted or unsubstituted C₆-C₂₀ arylene group, a substituted or unsubstituted C₃-C₂₀ heteroarylene
group,

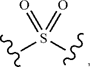

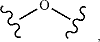

—O—R′—, —R′—O—R″—, or a combination thereof;
where R′ and R″ are each independently selected from a substituted or unsubstituted C₁-C₂₀ alkylidene group, a substituted or unsubstituted C₂-C₂₀ alkenylene group, or a substituted or unsubstituted C₂-C₂₀ alkynylene group;
where when the groups are substituted, substituents are each independently selected from halogen, a cyano group, a C₁-C₂₀ alkyl group, a C₃-C₂₀ cycloalkyl group, a C₂-C₂₀ alkenyl group, a C₆-C₂₀ aryl group, or a C₆-C₂₀ heteroaryl group; and
where the heteroatom is selected from one or more of O, S, N, and P; and
where based on the total weight of the electrolyte, a content of the compound containing sulfur-oxygen double bonds is 0.01 wt% to 10 wt%.

In some embodiments, the compound containing sulfur-oxygen double bonds includes at least one of the following compounds:

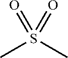

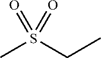

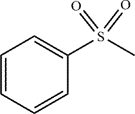

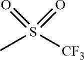

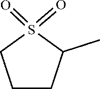

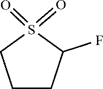

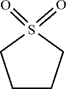

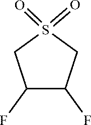

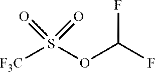 [SMILES: O=S(=O)(OC(F)F)C(F)(F)F]

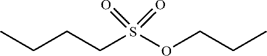

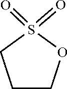

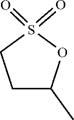

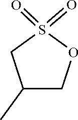

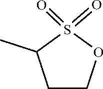

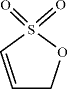

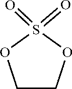

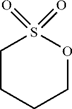

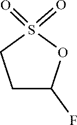

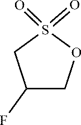

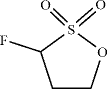

, or

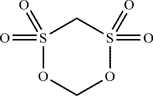

In some embodiments, the electrolyte further includes a cyclic carbonate compound that includes a compound of formula III:

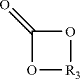

where R₃ is selected from a substituted or unsubstituted C₁-C₂₀ alkylidene group, or a substituted or unsubstituted C₂-C₂₀ alkenylene group;
where when R₃ is substituted, a substituent is selected from halogen, a C₁-C₆ alkyl group, a C₂-C₆ alkenyl group, a C₆-C₂₀ aryl group, or a C₆-C₂₀ heteroaryl group, where the heteroatom is selected from one or more of O, S, N, and P; and
in some embodiments, based on the total weight of the electrolyte, a content of the cyclic carbonate compound is 0.01 wt% to 40 wt%.

In some embodiments, the cyclic carbonate compound includes at least one of the following compounds:

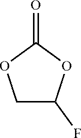

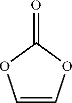

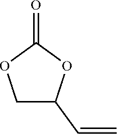

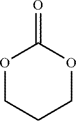

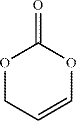

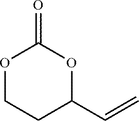

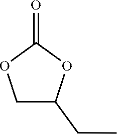

, or

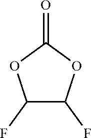

In another embodiment of this application, an electrochemical apparatus is provided, and includes a positive electrode, a negative electrode, a separator and the electrolyte described in the embodiments of this application.

In some embodiments, the positive electrode includes a current collector and a positive active material layer on the current collector, and the positive active material layer includes a positive active material, where the positive active material includes an element A, and the element A includes at least one of Mg, Ti, Zr, Y, Zn, La, Al, W, or Si.

In some embodiments, based on a total weight of the positive active material, a content of the element A is 50 ppm to 8000 ppm.

In some embodiments, the separator includes a polyolefin substrate layer and a coating on at least one surface of the polyolefin substrate layer, and a thickness ratio of the substrate layer to the coating is 1:1 to 5:1.

In some embodiments, the coating includes a polymer, and the polymer includes at least one of the following compounds: polytetrafluoroethylene, polyvinylidene fluoride, a tetrafluoroethylene-perfluorinated alkyl vinyl ether copolymer, an ethylene-tetrafluoroethylene copolymer, an ethylene-chlorotrifluoroethylene copolymer, a perfluorinated ethylene-propylene copolymer, acrylic acid, methacrylic acid, itaconic acid, ethyl acrylate, butyl acrylate, acrylonitrile, or methacrylonitrile.

In some embodiments, the coating further includes inorganic particles, and the inorganic particles include at least one of the following compounds: aluminum oxide, silicon dioxide, magnesium oxide, titanium oxide, hafnium dioxide, tin oxide, ceria oxide, nickel oxide, zinc oxide, calcium oxide, zirconium oxide, yttrium oxide, silicon carbide, boehmite, aluminum hydroxide, magnesium hydroxide, calcium hydroxide, or barium sulfate.

In another embodiment of this application, an electronic apparatus is provided, and includes the electrochemical apparatus according to the embodiments of this application.

A lithium-ion battery prepared by using the electrolyte according to this application has the controlled cyclic swelling, and the improved high-temperature storage performance and hot-box testing performance.

Additional aspects and advantages of the embodiments of this application are partially described and presented in the later description, or explained by implementation of the embodiments of this application.

### DETAILED DESCRIPTION OF EMBODIMENTS

Embodiments of this application are described in detail below. The embodiments of this application shall not be construed as a limitation on this application.

In the embodiments and claims, a list of items preceded by the terms such as “one of”, “one type of”, or other similar terms may mean any one of the listed items. For example, if items A and B are listed, the phrase “one of A and B” means only A or only B. In another example, if items A, B, and C are listed, the phrase “one of A, B, and C” means only A, only B, or only C. The item A may contain one element or a plurality of elements. The item B may contain one element or a plurality of elements. The item C may contain one element or a plurality of elements.

In the embodiments and claims, a list of items preceded by the terms such as “at least one of”, “at least one type of”, or other similar terms may mean any combination of the listed items. For example, if items A and B are listed, the phrase “one of A and B” means only A, only B, or A and B. In another example, if items A, B, and C are listed, the phrase “at least one of A, B, and C” means only A, only B, only C, A and B (excluding C), A and C (excluding B), B and C (excluding A), or all of A, B, and C. The item A may contain one element or a plurality of elements. The item B may contain one element or a plurality of elements. The item C may contain one element or a plurality of elements.

As used herein, the term “alkyl group” is intended to be a straight-chain saturated hydrocarbon structure having 1 to 20 carbon atoms. The term “alkyl group” is also intended to be a branched or cyclic hydrocarbon structure having 3 to 20 carbon atoms. For example, an alkyl group may be an alkyl group having 1 to 20 carbon atoms, an alkyl group having 1 to 10 carbon atoms, an alkyl group having 1 to 5 carbon atoms, an alkyl group having 5 to 20 carbon atoms, an alkyl group having 5 to 15 carbon atoms, or an alkyl group having 5 to 10 carbon atoms. References to an alkyl group with a specific carbon number are intended to cover all geometric isomers with the specific carbon number. Therefore, for example, “butyl” is meant to include n-butyl, sec-butyl, isobutyl, tert-butyl, and cyclobutyl; and “propyl” includes n-propyl, isopropyl, and cyclopropyl. Examples of the alkyl group include, but are not limited to, methyl, ethyl, n-propyl, isopropyl, cyclopropyl, n-butyl, isobutyl, sec-butyl, tert-butyl, cyclobutyl, n-pentyl, isopentyl, neopentyl, cyclopentyl, methylcyclopentyl, ethylcyclopentyl, n-hexyl, isohexyl, cyclohexyl, n-heptyl, octyl, cyclopropyl, cyclobutyl, norbornyl, and the like. In addition, the alkyl group may be arbitrarily substituted.

As used herein, the term “cycloalkyl group” covers cyclic alkyl groups. A cycloalkyl group may be a cycloalkyl group having 3 to 20 carbon atoms, a cycloalkyl group having 6 to 20 carbon atoms, a cycloalkyl group having 3 to 12 carbon atoms, or a cycloalkyl group having 3 to 6 carbon atoms. For example, the cycloalkyl group may be cyclopropyl, cyclobutyl, cyclopentyl, cyclohexyl, or the like. In addition, the cycloalkyl group may be arbitrarily substituted.

As used herein, the term “cycloalkylene group” covers cyclic alkylene groups. A cycloalkylene group may be a cycloalkylene group having 3 to 20 carbon atoms, a cycloalkylene group having 6 to 20 carbon atoms, a cycloalkylene group having 3 to 12 carbon atoms, or a cycloalkylene group having 3 to 6 carbon atoms. For example, the cycloalkylene group may be cyclopropylidene, cyclobutylidene, cyclopentylene, cyclohexylidene, or the like. In addition, the cycloalkylene group may be arbitrarily substituted.

As used herein, the term “alkenyl group” refers to a straight-chain or branched monovalent unsaturated hydrocarbon group having at least one and usually 1, 2, or 3 carbon-carbon double bonds. Unless otherwise defined, the alkenyl group generally contains 2 to 20 carbon atoms. For example, the alkenyl group may be an alkenyl group having 2 to 20 carbon atoms, an alkenyl group having 6 to 20 carbon atoms, an alkenyl group having 2 to 12 carbon atoms, or an alkenyl group having 2 to 6 carbon atoms. Representative alkenyl groups include, for example, vinyl, n-propenyl, isopropenyl, n-but-2-enyl, but-3-enyl, and n-hex-3-enyl. In addition, the alkenyl group may be arbitrarily substituted.

The term “alkynyl group” refers to a straight-chain or branched monovalent unsaturated hydrocarbon group having at least one and usually 1, 2, or 3 carbon-carbon triple bonds. Unless otherwise defined, the alkynyl group generally contains 2 to 20 carbon atoms. For example, the alkynyl group may be an alkynyl group having 2 to 20 carbon atoms, an alkynyl group having 6 to 20 carbon atoms, an alkynyl group having 2 to 10 carbon atoms, or an alkynyl group having 2 to 6 carbon atoms. Representative alkynyl groups include, for example, ethynyl, prop-2-ynyl (n-propynyl), n-but-2-ynyl, and n-hex-3-ynyl. In addition, the alkynyl group may be arbitrarily substituted.

As used herein, the term “alkylidene group” means a straight-chain or branched divalent saturated hydrocarbon group. For example, an alkylidene group may be an alkylidene group having 1 to 20 carbon atoms, an alkylidene group having 1 to 15 carbon atoms, an alkylidene group having 1 to 10 carbon atoms, an alkylidene group having 1 to 5 carbon atoms, an alkylidene group having 5 to 20 carbon atoms, an alkylidene group having 5 to 15 carbon atoms, or an alkylidene group having 5 to 10 carbon atoms. Representative alkylidene groups include, for example, methylene, ethane-1,2-diyl (“ethylene”), propane-1,2-diyl, propane-1,3-diyl, butane-1,4-diyl, and pentane-1,5-diyl. In addition, the alkylidene group may be arbitrarily substituted.

As used herein, the term “alkenylene group” covers straight-chain and branched alkenylene groups. References to an alkenylene group with a specific carbon number are intended to cover all geometric isomers with the specific carbon number. For example, an alkenylene group may be an alkenylene group having 2 to 20 carbon atoms, an alkenylene group having 2 to 15 carbon atoms, an alkenylene group having 2 to 10 carbon atoms, an alkenylene group having 2 to 5 carbon atoms, an alkenylene group having 5 to 20 carbon atoms, an alkenylene group having 5 to 15 carbon atoms, or an alkenylene group having 5 to 10 carbon atoms. Representative alkenylene groups include, for example, vinylene, propenylene, and butenylene. In addition, the alkenylene group may be arbitrarily substituted.

As used herein, the term “alkynylene group” covers straight-chain and branched alkynylene groups. References to an alkynylene group with a specific carbon number are intended to cover all geometric isomers with the specific carbon number. For example, an alkynylene group may be an alkynylene group having 2 to 20 carbon atoms, an alkynylene group having 2 to 15 carbon atoms, an alkynylene group having 2 to 10 carbon atoms, an alkynylene group having 2 to 5 carbon atoms, an alkynylene group having 5 to 20 carbon atoms, an alkynylene group having 5 to 15 carbon atoms, or an alkynylene group having 5 to 10 carbon atoms. Representative alkynylene groups include, for example, ethynylene, propinylene, and butynelene. In addition, the alkynylene group may be arbitrarily substituted.

As used herein, the term “aryl group” covers a monocyclic system and a polycyclic system. The polycyclic system may have two or more cycles with two of carbon atoms shared by two adjacent cycles (which are “condensed”), where at least one of the cycles is aromatic. For example, other cycles may be a cycloalkyl group, a cycloalkenyl group, an aryl group, a heterocycle, and/or a heteroaryl group. For example, the aryl group may be a C₆-C₅₀ aryl group, a C₆-C₄₀ aryl group, a C₆-C₃₀ aryl group, a C₆-C₂₀ aryl group, or a C₆-C₁₀ aryl group. Representative aryl groups include, for example, phenyl, methylphenyl, propylphenyl, isopropylphenyl, benzyl, naphth-1-yl, and naphth-2-yl. In addition, the aryl group may be arbitrarily substituted.

As used herein, an “arylene group” covers a monocyclic system and a polycyclic system. For example, the arylene group may be a C₆-C₅₀ arylene group, a C₆-C₄₀ arylene group, a C₆-C₃₀ arylene group, a C₆-C₂₀ arylene group, or a C₆-C₁₀ arylene group. Representative arylene groups include, for example, phenylene, methylene phenyl, propylene phenyl, isopropylidene phenyl, and benzylidene. In addition, the arylene group may be arbitrarily substituted.

As used herein, the term “heteroaryl group” covers monocyclic heteromatic groups, each of which may contain one to three heteroatoms, for example, pyrrole, furan, thiophene, imidazole, oxazole, thiazole, triazole, pyrazole, pyridine, pyrazine, and pyrimidine. The term “heteroaryl group” further includes a polycyclic aromatic system having two or more cycles with two of atoms shared by two adjacent cycles (which are “condensed”), where at least one of the cycles is a heteroaryl group, and other cycles may be a cycloalkyl group, a cycloalkenyl group, an aryl group, a heterocycle, and/or a heteroaryl group. A heteroatom of the heteroaryl group may be, for example, O, S, N, or Se. For example, the heteroaryl group may be a C₃-C₅₀ heteroaryl group, a C₃-C₄₀ heteroaryl group, a C₃-C₃₀ heteroaryl group, a C₃-C₂₀ heteroaryl group, or a C₃-C₁₀ heteroaryl group. In addition, the heteroaryl group may be arbitrarily substituted.

As used herein, the term “heteroarylene group” covers monocyclic or polycyclic heteroarylene groups each may contain one to three heteroatoms. For example, the heteroarylene group may be a C₃-C₅₀ heteroarylene group, a C₃-C₄₀ heteroarylene group, a C₃-C₃₀ heteroarylene group, a C₃-C₂₀ heteroarylene group, or a C₃-C₁₀ heteroarylene group. In addition, the heteroarylene group may be arbitrarily substituted.

As used herein, the term “heteroatom” covers O, S, P, N, B, or isosteres thereof.

As used herein, the term “halogen” covers F, Cl, Br, and I.

As used herein, the term “covalent bond” covers single bonds.

When substituted, substituents of the groups each may be independently selected from a group including halogen, an alkyl group, an alkenyl group, and an aryl group. As used herein, the term “substitute” or “substituted” means that it may be substituted with 1 or more (for example, 2 or 3) substituents.

As used herein, the content of each component is obtained based on the total weight of the electrolyte.

### I. Electrolyte

In some embodiments of this application, an electrolyte is provided, and includes a compound of formula I:

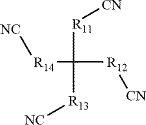

where Rn is selected from a covalent bond, a substituted or unsubstituted C₁-C₂₀ alkylidene group, a substituted or unsubstituted C₂-C₂₀ alkenylene group, a substituted or unsubstituted C₂-C₂₀ alkynylene group, a substituted or unsubstituted C₆-C₂₀ arylene group, a substituted or unsubstituted C₃-C₂₀ heteroarylene group, a substituted or unsubstituted C₃-C₂₀ cycloalkylene group,

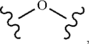

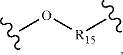

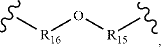

or a combination thereof;
where R₁₂, R₁₃, and R₁₄ are each independently selected from a substituted or unsubstituted C₁-C₂₀ alkylidene group, a substituted or unsubstituted C₂-C₂₀ alkenylene group, a substituted or unsubstituted C₂-C₂₀ alkynylene group, a substituted or unsubstituted C₆-C₂₀ arylene group, a substituted or unsubstituted C₃-C₂₀ heteroarylene group, a substituted or unsubstituted C₃-C₂₀ cycloalkylene group,

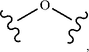

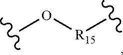

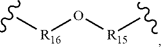

or a combination thereof;
where R₁₅ and R₁₆ are each independently selected from a C₁-C₂₀ alkylidene group, a substituted or unsubstituted C₂-C₂₀ alkenylene group, a substituted or unsubstituted C₂-C₂₀ alkynylene group, a substituted or unsubstituted C₆-C₂₀ arylene group, a substituted or unsubstituted C₃-C₂₀ heteroarylene group, or a substituted or unsubstituted C₃-C₂₀ cycloalkylene group;
where when the groups are substituted, substituents are each selected from halogen, a C₁-C₂₀ alkyl group, a C₃-C₂₀ cycloalkyl group, a C₂-C₂₀ alkenyl group, a C₆-C₂₀ aryl group, or a C₃-C₂₀ heteroaryl group; and
where a heteroatom is selected from one or more of O, S, N, and P.

In some embodiments, R₁₁ is selected from a covalent bond, a substituted or unsubstituted C₁-C₁₀ alkylidene group,

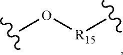

or a group obtained by optionally combining the above groups, where R₁₅ is selected from a C₁-C₁₀ alkylidene group;
R₁₂, R₁₃, and R₁₄ are each independently selected from a substituted or unsubstituted C₁-C₁₀ alkylidene group, a substituted or unsubstituted C₂-C₁₀ alkenylene group, a substituted or unsubstituted C₂-C₁₀ alkynylene group, a substituted or unsubstituted C₆-C₁₀ arylene group,

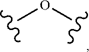

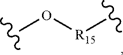

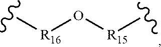

or a group obtained by optionally combining the above groups, where R₁₅ and R₁₆ each are independently selected from a C₁-C₁₀ alkylidene group; and
where when the groups are substituted, substituents each are independently selected from halogen or a C₁-C₁₀ alkyl group.

In some embodiments, R₁₁ is selected from a covalent bond, a C₁-C₆ alkylidene group,

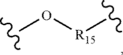

or a group obtained by optionally combining the above groups, where R₁₅ is selected from a C₁-C₆ alkylidene group;
R₁₂, R₁₃, and R₁₄ are each independently selected from a C₁-C₆ alkylidene group, a C₂-C₃ alkenylene group, a C₂-C₃ alkynylene group, a substituted or unsubstituted phenylene group,

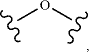

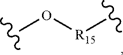

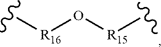

or a group obtained by optionally combining the above groups, where R₁₅ and R₁₆ each are independently selected from a C₁-C₆ alkylidene group; and
where when the groups are substituted, substituents each are independently selected from halogen or a C₁-C₆ alkyl group.

In some embodiments, R₁₁ is selected from a covalent bond, ethylene or

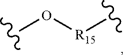

where R₁₅ is ethylene;

R₁₂, R₁₃ and R₁₄ are each independently selected from methylene, ethylene, propylene, butylene, pentylene, a substituted or unsubstituted phenylene,

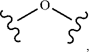

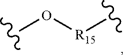

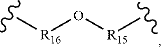

or a group obtained by optionally combining the above groups, where R₁₅ and R₁₆ each are independently selected from methylene, ethylene, propenyl, or propynyl.

In some embodiments, the compound of formula I includes or is selected from at least one of the following compounds:

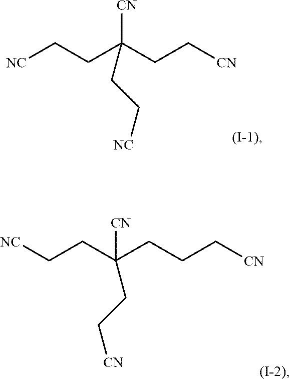

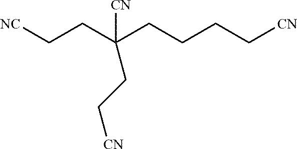

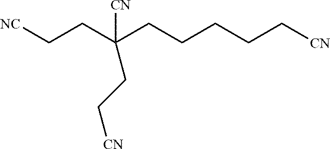

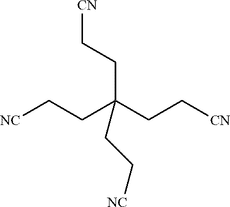

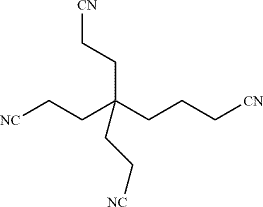

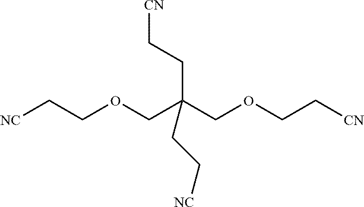

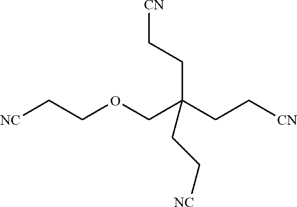

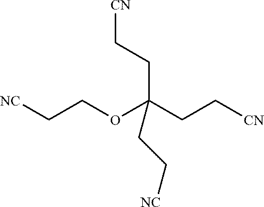

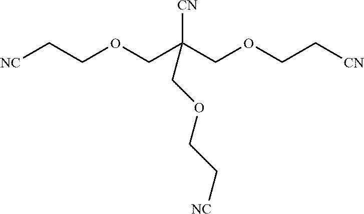

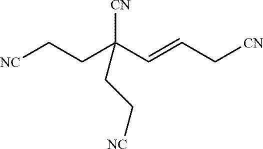

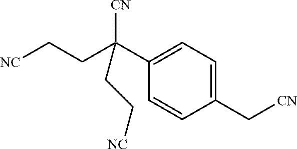

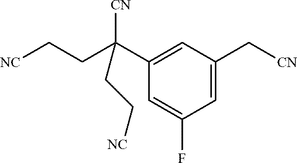

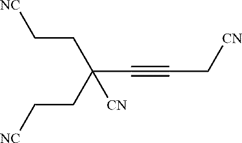

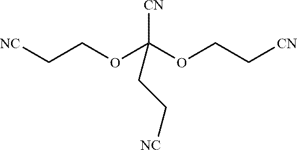

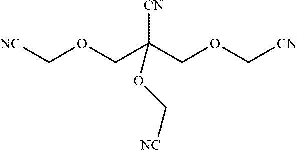

or

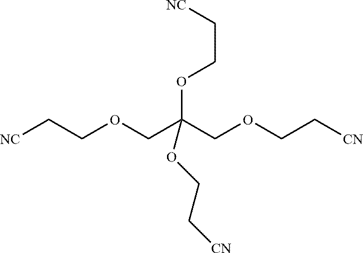

In some embodiments, based on the total weight of the electrolyte, the content of the compound of formula I is 0.01 wt% to 10 wt%. In some embodiments, based on the total weight of the electrolyte, the content of the compound of formula I is 0.01 wt%, 0.05 wt%, 0.1 wt%, 0.5 wt%, 1 wt%, 1.5 wt%, 2 wt%, 3 wt%, 4 wt%, 5 wt%, 6 wt%, 7 wt%, 8 wt%, 9 wt%, 10 wt%, or within a range of any two of the values.

After extensive research in this application, it is found that the compound of formula I may form a nitrile protective film with excellent performance on a surface of a positive active material, and may effectively stabilize transition metals such as nickel, cobalt, and manganese in the positive active material. If the number of short chains in R₁₁, R₁₂, R₁₃, and R₁₄ linked to a cyano group is too large, for example, when both Rn and R₁₂ are covalent bonds, a poor stabilization effect on the positive active material may be caused. The electrolyte that includes a compound containing -CN functional groups may significantly improve the floating charge performance, high-temperature storage performance and thermal shock performance of an electrochemical apparatus using the electrolyte.

In some embodiments, the electrolyte further includes a compound containing sulfur-oxygen double bonds, and the compound containing sulfur-oxygen double bonds includes a compound of formula (II-A), a compound of formula (II-B), or a combination thereof:

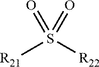

, and

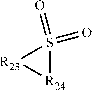

where R₂₁ and R₂₂ are each independently selected from a substituted or unsubstituted C₁-C₂₀ alkyl group, a substituted or unsubstituted C₂-C₂₀ alkenyl group, a substituted or unsubstituted C₂-C₂₀ alkynyl group, a substituted or unsubstituted C₆-C₂₀ aryl group, a substituted or unsubstituted C₃-C₂₀ heteroaryl group, a substituted or unsubstituted C₃-C₂₀ cycloalkyl group, —O—R₂₅, or —R₂₆—O—R₂₇;
where R₂₅ and R₂₇ are each independently selected from a substituted or unsubstituted C₁-C₂₀ alkyl group, a substituted or unsubstituted C₂-C₂₀ alkenyl group, a substituted or unsubstituted C₂-C₂₀ alkynyl group, a substituted or unsubstituted C₆-C₂₀ aryl group, a substituted or unsubstituted C₃-C₂₀ heteroaryl group, or a substituted or unsubstituted C₃-C₂₀ cycloalkyl group;
where R₂₆ is selected from a substituted or unsubstituted C₁-C₂₀ alkylidene group, a substituted or unsubstituted C₂-C₂₀ alkenylene group, a substituted or unsubstituted C₂-C₂₀ alkynylene group, a substituted or unsubstituted C₆-C₂₀ arylene group, a substituted or unsubstituted C₃-C₂₀ heteroarylene group, or a substituted or unsubstituted C₃-C₂₀ cycloalkylene group;
where R₂₃ and R₂₄ are each independently selected from a substituted or unsubstituted C₁-C₂₀ alkylidene group, a substituted or unsubstituted C₂-C₂₀ alkenylene group, a substituted or unsubstituted C₂-C₂₀ alkynylene group, a substituted or unsubstituted C₆-C₂₀ arylene group, a substituted or unsubstituted C₃-C₂₀ heteroarylene group,

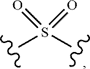

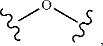

—O—R′—, —R′—O—R″—, or a group obtained by optionally combining the above groups;
where R′ and R″ are each independently selected from a substituted or unsubstituted C₁-C₂₀ alkylidene group, a substituted or unsubstituted C₂-C₂₀ alkenylene group, or a substituted or unsubstituted C₂-C₂₀ alkynylene group;
where when the groups are substituted, substituents are each independently selected from halogen, a cyano group, a C₁-C₂₀ alkyl group, a C₃-C₂₀ cycloalkyl group, a C₂-C₂₀ alkenyl group, a C₆-C₂₀ aryl group, or a C₆-C₂₀ heteroaryl group;
where a heteroatom is selected from one or more of O, S, N, and P.

In some embodiments, R₂₁ and R₂₂ are each independently selected from a substituted or unsubstituted C₁-C₁₀ alkyl group, a substituted or unsubstituted C₂-C₁₀ alkenyl group, a substituted or unsubstituted C₂-C₁₀ alkynyl group, a substituted or unsubstituted C₆-C₁₀aryl group, a substituted or unsubstituted C₃-C₁₀ heteroaryl group, a substituted or unsubstituted C₃-C₁₀ cycloalkyl group, —O—R₂₅, or —R₂₆—O—R₂₇;
where R₂₅ and R₂₇ are each independently selected from a substituted or unsubstituted C₁-C₁₀ alkyl group, a substituted or unsubstituted C₂-C₁₀ alkenyl group, a substituted or unsubstituted C₂-C₁₀ alkynyl group, a substituted or unsubstituted C₆-C₁₀ aryl group, a substituted or unsubstituted C₃-C₁₀ heteroaryl group, or a substituted or unsubstituted C₃-C₁₀ cycloalkyl group;
where R₂₆ is selected from a substituted or unsubstituted C₁-C₁₀ alkylidene group, a substituted or unsubstituted C₂-C₁₀ alkenylene group, a substituted or unsubstituted C₂-C₁₀ alkynylene group, a substituted or unsubstituted C₆-C₁₀ arylene group, a substituted or unsubstituted C₃-C₁₀ heteroarylene group, or a substituted or unsubstituted C₃-C₁₀ cycloalkylene group; and
where when the groups are substituted, substituents are each independently selected from halogen, a cyano group, a C₁-C₁₀ alkyl group, a C₃-C₁₀ cycloalkyl group, a C₂-C₁₀ alkenyl group, a C₆-C₁₀ aryl group, or a C₆-C₁₀ heteroaryl group.

In some embodiments, R₂₁ and R₂₂ are each selected from a substituted or unsubstituted C₁-C₆ alkyl group, a substituted or unsubstituted C₆-C₁₀ aryl group, —OR₂₅, or —R₂₆—O—R₂₇;
where R₂₅ and R₂₇ are each independently selected from a substituted or unsubstituted C₁-C₆ alkyl group;
where R₂₆ is selected from a substituted or unsubstituted C₁-C₆ alkylidene group; and
where when the above groups are substituted, substituents are each independently selected from halogen.

In some embodiments, R₂₃ and R₂₄ are each independently selected from a substituted or unsubstituted C₁-C₁₀ alkylidene group, a substituted or unsubstituted C₂-C₁₀ alkenylene group, a substituted or unsubstituted C₂-C₁₀ alkynylene group, a substituted or unsubstituted C₆-C₁₀ arylene group, a substituted or unsubstituted C₃-C₁₀ heteroarylene group,

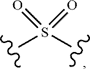

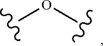

—O—R′—, —R′—O—R″—, or a group obtained by optionally combining the above groups;
where R′ and R″ are each independently selected from a substituted or unsubstituted C₁-C₁₀ alkylidene group, a substituted or unsubstituted C₂-C₁₀ alkenylene group, or a substituted or unsubstituted C₂-C₁₀ alkynylene group; and
where when the groups are substituted, substituents are each independently selected from halogen, a cyano group, a C₁-C₁₀ alkyl group, a C₃-C₁₀ cycloalkyl group, a C₂-C₁₀ alkenyl group, a C₆-C₁₀ aryl group, or a C₆-C₁₀ heteroaryl group.

In some embodiments, R₂₃ and R₂₄ are each independently selected from a substituted or unsubstituted C₁-C₁₀ alkylidene group, a substituted or unsubstituted C₂-C₁₀ alkenylene group,

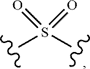

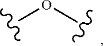

—O—R′—, —R′—O—R″—, or a group obtained by optionally combining the above groups;
where R′ and R″ are each independently selected from a substituted or unsubstituted C₁-C₁₀ alkylidene group, or a substituted or unsubstituted C₂-C₁₀ alkenylene group; and
where when the groups are substituted, substituents each are independently selected from halogen or a C₁-C₁₀ alkyl group.

In some embodiments, R₂₃ and R₂₄ are each independently selected from a substituted or unsubstituted C₁-C₆ alkylidene group, a substituted or unsubstituted C₂-C₆ alkenylene group,

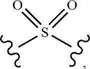

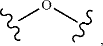

—O—R′—, —R′—O—R″—, or a group obtained by optionally combining the above groups;
where R′ and R″ are each independently selected from a substituted or unsubstituted C₁-C₆ alkylidene group, or a substituted or unsubstituted C₂-C₆ alkenylene group; and
where when the groups are substituted, substituents are each independently selected from F or methyl.

In some embodiments, based on the total weight of the electrolyte, the content of the compound containing sulfur-oxygen double bonds is 0.01 wt% to 10 wt%. In some embodiments, based on the total weight of the electrolyte, the content of the compound containing sulfur-oxygen double bonds is 0.01 wt%, 1 wt%, 2 wt%, 3 wt%, 4 wt%, 5 wt%, 6 wt%, 7 wt%, 8 wt%, 9 wt%, 10 wt%, or within a range of any two of the values.

In some embodiments, the compound containing sulfur-oxygen double bonds includes at least one of the following compounds:

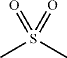

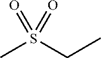

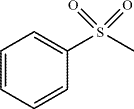

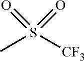

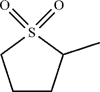

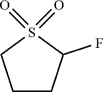

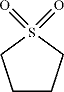

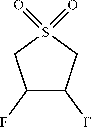

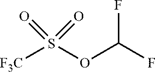 [SMILES: O=S(=O)(OC(F)F)C(F)(F)F]

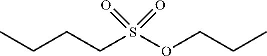

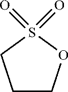

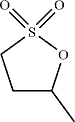

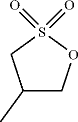

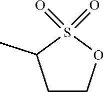

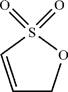

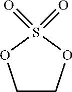

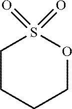

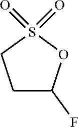

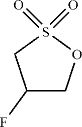

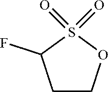

or

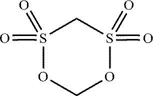

In this application, it is found that combined the compound of formula I and the compound containing sulfur-oxygen double bonds, the electrolyte has a strong a strong oxidation resistance capacity, so that a positive electrode material is not easy to be oxidized. In addition, in the case of lithium plating in a negative electrode, the compounds will be reduced on a surface of lithium metal to form a protective film layer to inhibit heat generation in decomposition of the lithium metal and the electrolyte, thereby further protecting the active material.

In some embodiments, the electrolyte further includes a cyclic carbonate compound that includes a compound of formula III:

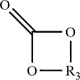

where R₃ is selected from a substituted or unsubstituted C₁-C₂₀ alkylidene group, or a substituted or unsubstituted C₂-C₂₀ alkenylene group; and
where when R₃ is substituted, the substituent is selected from halogen, a C₁-C₆ alkyl group, a C₂-C₆ alkenyl group, a C₆-C₂₀ aryl group, or a C₆-C₂₀ heteroaryl group, where the heteroatom is selected from one or more of O, S, N, and P.

In some embodiments, R₃ is selected from a substituted or unsubstituted C₁-C₁₀ alkylidene group, or a substituted or unsubstituted C₂-C₁₀ alkenylene group; and

when R₃ is substituted, the substituent is selected from halogen, a C₁-C₆ alkyl group, or a C₂-C₆ alkenyl group.

In some embodiments, based on the total weight of the electrolyte, the content of the cyclic carbonate compound is 0.01 wt% to 40 wt%. In some embodiments, based on the total weight of the electrolyte, the content of the cyclic carbonate compound is 0.01 wt%, 0.05 wt%, 1 wt%, 2 wt%, 3 wt%, 4 wt%, 5 wt%, 6 wt%, 7 wt%, 8 wt%, 9 wt%, 10 wt%, 15 wt%, 20 wt%, 25 wt%, 30 wt%, 35 wt%, 40 wt%, or within a range of any two of the values.

In some embodiments, the cyclic carbonate compound includes at least one of the following compounds:

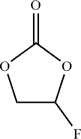

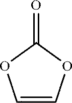

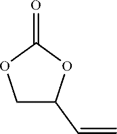

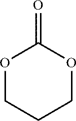

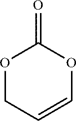

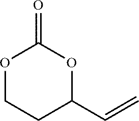

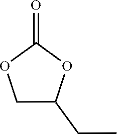

, and

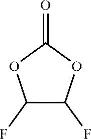

In some embodiments, the electrolyte further includes a polynitrile compound, and the polynitrile compound includes at least one of pentane-1,3,5-tricarbonitrile, propane-1,2,3-tricarbonitrile, hexane-1,3,6-tricarbonitrile, hexane-1,2,6-tricarbonitrile, 1,2,3-tris(2-cyanoethoxy)propane, 1,2,4-tris(2-cyanoethoxy)butane, 3,3′-((2-((2-cyanoethoxy)methyl)-2-methylpropane-1,3-diyl)bis(oxy))dipropanenitrile, 3,3′-((2-((2-cyanoethoxy)methyl)-2-ethylpropane-1,3-diyl)bis(oxy))dipropanenitrile, 3,3′,3″-((3-methylpentane-1,3,5-triyl)tris(oxy))tripropanenitrile, 3,3′,3″-(heptane-1,2,7-triyltris(oxy))tripropanenitrile, 3,3′,3″-(hexane-1,2,6-triyltris(oxy))tripropanenitrile, and 3,3′,3″-(pentane-1,2,5-triyltris(oxy))tripropanenitrile.

In some embodiments, the electrolyte further includes a cyclic ether. The cyclic ether may form films on positive and negative electrodes simultaneously, to reduce reaction between the electrolyte and the active material.

In some embodiments, the cyclic ether includes, but is not limited to: tetrahydrofuran, 2-methyltetrahydrofuran, 1,3-dioxolane, 2-methyl 1,3-dioxolane, 4-methyl 1,3-dioxolane, 1,3-dioxane, 1,4-dioxane, 1,1-dimethoxypropane, 1,2-dimethoxypropane and 1,3-dimethoxypropane.

In some embodiments, based on the total weight of the electrolyte, the cntent of the cyclic ether is 0.1 wt% to 10 wt%. In some embodiments, based on the total weight of the electrolyte, the content of the cyclic ether is greaterthan or equel to 0.1 wt%. In some embodiments, based on the total weight of the electrolyte, the content of the cyclic ether is greater than or equel to 0.5 wt%. In some embodiments, based on the total weight of the electrolyte, the content of the cyclic ether is less than or equel to 2 wt%. In some embodiments, based on the total weight of the electrolyte, the content of the cyclic ether isleess than or equel to 5 wt%.

In some embodiments, the electrolyte further includes a linear ether. In some embodiments, the linear ether includes, but is not limited to: dimethoxymethane, 1,1-dimethoxyethane, 1,2-dimethoxyethane, diethoxymethane, 1,1-diethoxyethane, 1,2-diethoxyethane, (methoxymethoxy)ethane, 1-ethoxy-1-methoxyethane, and 1-ethoxy-2-methoxy ethane.

In some embodiments, based on the total weight of the electrolyte, the content of the linear ether is 0.1 wt% to 10 wt%. In some embodiments, based on the total weight of the electrolyte, the content of the linear ether is greater than or equel to 0.5 wt%. In some embodiments, based on the total weight of the electrolyte, the content of the linear ether is greater than or equel to 2 wt%. In some embodiments, based on the total weight of the electrolyte, the content of the linear ether is greater than or equel to 3 wt%. In some embodiments, based on the total weight of the electrolyte, the content of the linear ether is less than or equel to 10 wt%. In some embodiments, based on the total weight of the electrolyte, the percentage by weight of the linear ether is less greater than or equel to 5 wt%.

In some embodiments, the electrolyte further includes an aromatic fluorine-containing solvent. The aromatic fluorine-containing solvent may formed a protectfilm-quickly to protect the active material, and an infiltration performance of the electrolyte to the active material may be improved by the fluorine-containing material. In some embodiments, the aromatic fluorine-containing solvent includes, but is not limited to: fluorobenzene, difluorobenzene, trifluorobenzene, tetrafluorobenzene, pentafluorobenzene, hexafluorobenzene, and benzotrifluoride.

In some embodiments, based on the total weight of the electrolyte, the content of the aromatic fluorine-containing solvent is 0.1 wt% to 10 wt%. In some embodiments, based on the total weight of the electrolyte, the pcontent of the aromatic fluorine-containing solvent is greater than or equel to 0.5 wt%. In some embodiments, based on the total weight of the electrolyte, the content of the aromatic fluorine-containing solvent is greater than or equel to 2 wt%. In some embodiments, based on the total weight of the electrolyte, the content of the aromatic fluorine-containing solvent is less than or equel to 4 wt%. In some embodiments, based on the total weight of the electrolyte, the content of the aromatic fluorine-containing solvent is less than or equel to 8 wt%.

In some embodiments, the electrolyte further includes a lithium-salt additive. In some embodiments, the lithium-salt additive includes at least one of the following compounds: bis(trifluoromethane)sulfonimide lithium salt LiN(CF₃SO₂)₂ (LiTFSI for short), lithium bis(fluorosulfonyl)imide Li(N(SO₂F)₂) (LiFSI for short), lithium bis(oxalato)borate LiB(C₂O₄)₂ (LiBOB for short), Lithium tetrafluoro(oxalato)phosphate (LiPF₄C₂O₂), lithium difluoro(oxalato)borate LiBF₂(C₂O₄) (LiDFOB for short), lithium difluorophosphate(LiPO₂F₂), and lithium tetrafluorooxalatophosphate(LiTFOP).

In some embodiments, based on the total weight of the electrolyte, the percentage by weight of the lithium-salt additive is 0.01 wt% to 10 wt%. In some embodiments, based on the total weight of the electrolyte, thecontent of the lithium-salt additive is 0.01 wt% to 5 wt%. In some embodiments, based on the total weight of the electrolyte, the content of the lithium-salt additive is 0.01 wt% to 1 wt%. In some embodiments, based on the total weight of the electrolyte, the content of the lithium-salt additive is 0.01 wt% to 0.9 wt%. In some embodiments, based on the total weight of the electrolyte, the content of the lithium-salt additive is 0.01 wt%, 0.05 wt%, 0.1 wt%, 0.3 wt%, 0.5 wt%, 0.7 wt%, 0.9 wt%, 1 wt%, 3 wt%, 5 wt%, 7 wt%, 9 wt%, 10 wt%, or within a range of any two of the values.

### II. Electrolyte

In the embodiments of this application, an electrolyte used in the electrolyte may be an electrolyte known in the prior art, including but not limited to LiClO₄, LiAsF₆, LiPF₆, LiBF₄, LiSbF₆, LiSO₃F, LiN(FSO₂)₂, and the like. In addition, the above electrolyte may be used singly, or two or more electrolytes may be used simultaneously. For example, in some embodiments, the electrolyte includes a combination of LiPF₆ and LiBF₄. In some embodiments, a concentration of the electrolyte is within a range of 0.8 mol/L to 3 mol/L, for example, a range of 0.8 mol/L to 2.5 mol/L, a range of 0.8 mol/L to 2 mol/L, a range of 1 mol/L to 2 mol/L, a range of 0.5 mol/L to 1.5 mol/L, a range of 0.8 mol/L to 1.3 mol/L, and a range of 0.5 mol/L to 1.2 mol/L, or is 1 mol/L, 1.15 mol/L, 1.2 mol/L, 1.5 mol/L, 2 mol/L, or 2.5 mol/L.

### III. Electrochemical Apparatus

An electrochemical apparatus according to this application includes any apparatus in which an electrochemical reaction takes place. Specific examples of the apparatus include all types of primary batteries, secondary batteries, fuel batteries, solar batteries, or capacitors. Especially, the electrochemical apparatus is a lithium secondary battery, including a lithium metal secondary battery, a lithium-ion secondary battery, a lithium polymer secondary battery, or a lithium-ion polymer secondary battery. In some embodiments, the electrochemical apparatus according to this application is an electrochemical apparatus provided with a positive electrode having a positive active material capable of occluding and releasing metal ions, and a negative electrode having a negative active material capable of occluding and releasing metal ions. The electrochemical apparatus is characterized by including the electrolyte in any one of the foregoing embodiments of this application.

### 1. Electrolyte

An electrolyte used in the electrochemical apparatus according to this application is the electrolyte in any one of the foregoing embodiments of this application.

In addition, the electrolyte used in the electrochemical apparatus according to this application may also include other electrolytes within the scope not departing from the essence of this application.

### 2. Negative Electrode

A material, a composition and a preparation method of a negative electrode used in the electrochemical apparatus according to this application may include any technology disclosed in the prior art. In some embodiments, the negative electrode is a negative electrode described in the U.S. Pat. Application US9812739B, which is incorporated in this application by reference in its entirety.

In some embodiments, the negative electrode includes a current collector and a negative active material layer on the current collector. The negative active material includes a material that reversibly intercalates/deintercalates lithium ions. In some embodiments, the material that reversibly intercalates/deintercalates lithium ions includes a carbon material. In some embodiments, the carbon material may be any carbon-based negative active material commonly used in a lithium-ion rechargeable battery. In some embodiments, the carbon material includes, but is not limited to: crystalline carbon, amorphous carbon, or a mixture thereof. The crystalline carbon may be amorphous, plate-shaped, flake-shaped, spherical or fiber-shaped natural graphite, or artificial graphite. The amorphous carbon may be soft carbon, hard carbon, mesophase pitch carbide, calcined coke, or the like.

In some embodiments, the negative active material layer includes a negative active material. In some embodiments, the negative active material includes, but is not limited to: lithium metal, structured lithium metal, natural graphite, artificial graphite, mesocarbon microbeads (MCMB), hard carbon, soft carbon, silicon, a silicon-carbon composite, a Li—Sn alloy, a Li—Sn—O alloy, Sn, SnO, SnO₂, spinel-structure lithiated TiO₂-Li₄Ti₅O₁₂, a Li—Al alloy, or any combination thereof.

When the negative electrode includes a silicon-carbon compound, based on a total weight of the negative active material, a ratio of silicon to carbon is equal to 1:10 to 10:1, and a median grain size Dv50 of the silicon-carbon compound is 0.1 µm to 100 µm. When the negative electrode includes an alloy material, the negative active material layer may be formed by a vapor deposition method, a sputtering method, a plating method, or the like. When the negative electrode includes lithium metal, for example, the negative active material layer can be formed by a spherical twisted conductive framework and metal particles dispersed in the conductive framework. In some embodiments, the spherical twisted conductive framework may have a porosity of 5% to 85%. In some embodiments, the negative active material layer with lithium metal may be further provided with a protective layer.

In some embodiments, the negative active material layer may include a binder, and optionally, may include a conductive material. The binder enhances binding between particles of the negative active material, and binding between the negative active material and the current collector. In some embodiments, the binder includes, but is not limited to: polyvinyl alcohol, carboxymethyl cellulose, hydroxypropyl cellulose, diacetyl cellulose, polyvinyl chloride, carboxylated polyvinyl chloride, polyvinyl fluoride, a polymer containing ethylene oxide, polyvinylpyrrolidone, polyurethane, polytetrafluoroethylene, poly(vinylidene fluoride), polyethylene, polypropylene, styrene-butadiene rubber, acrylic styrene-butadiene rubber, epoxy resin, nylon, and the like.

In some embodiments, the conductive material is includes, but not limited to: a carbon-based material, a metal-based material, a conductive polymer, or a mixture thereof. In some embodiments, the carbon-based material is selected from natural graphite, artificial graphite, carbon black, acetylene black, Ketjen black, carbon fibers, or any combination thereof. In some embodiments, the metal-based material is selected from metal powder, metal fibers, copper, nickel, aluminum, or silver. In some embodiments, the conductive polymer is a polyphenylene derivative.

In some embodiments, the current collector includes, but is not limited to: copper foil, nickel foil, stainless steel foil, titanium foil, nickel foam, copper foam, a polymer substrate coated with conductive metal, and any combination thereof.

The negative electrode may be prepared by using a preparation method known in the art. For example, the negative electrode may be obtained by using the following method: mixing an active material, a conductive material, and a binder in a solvent to prepare an active material composition, and coating a current collector with the active material composition. In some embodiments, the solvent may include but is not limited to water.

### 3. Positive Electrode

A material, a structure and a preparation method known in the art may be used to prepare a material for a positive electrode used in the electrochemical apparatus according to this application. In some embodiments, the positive electrode may be prepared by the technology described in the U.S. Pat. Application US9812739B, which is incorporated in this application by reference in its entirety.

In some embodiments, the positive electrode includes a current collector and a positive active material layer on the current collector, and the positive active material layer includes a positive active material.

In some embodiments, types of the positive active material are not limited particularly, as long as it can electrochemically absorb and release metal ions (for example, lithium ions). In some embodiments, the positive active material refers to a substance containing lithium and at least one transition metal. Examples of the positive active material may include, but are not limited to, a lithium and transition metal composite oxide and a lithium-containing transition metal phosphate compound.

In some embodiments, the lithium and transition metal composite oxide includes lithium-cobalt composite oxide (LiCoO₂), a lihtium-nickel composite oxide (LiNiO₂), a lithium-manganese composite oxide (for example, LiMnO₂, LiMn₂O₄, and Li₂MnO₄), and a lithium-nickel-manganese cobalt composite oxide (for example, LiNi_{⅓}Mn_{⅓}Co_{⅓}O₂, and LiNi_{0.5}Mn_{0.3}Co_{0.2}O₂).

In some embodiments, the positive active material further includes an element A. Based on a total weight of the positive active material, the content of the element A is 50 ppm to 3000 ppm. The element A includes at least one of Mg, Ti, Zr, Y, Zn, La, Al, W, or Si.

In some embodiments, a part of transition metal atoms of the main body of the lithium and transition metal composite oxide may be substituted with atoms of the element A.

In some embodiments, based on the total weight of the positive active material, the content of the element A is 50 ppm, 100 ppm, 200 ppm, 500 ppm, 1000 ppm, 1500 ppm, 2000 ppm, 2500 ppm, 3000 ppm, or within a range of any two of the values.

In some embodiments, the positive active material may be provided with a coating on its surface, or may be mixed with another compound having a coating. The coating may include at least one coating element compound selected from an oxide, a hydroxide, an oxyhydroxide, a bicarbonate, and a hydroxy carbonate of a coating element. Compounds for the coating may be amorphous or crystalline.

In some embodiments, the coating elements contained in the coating may include Mg, Co, K, Na, Ca, Si, Ti, V, Sn, Ge, Ga, B, As, Zr, F, or any combination thereof. The coating may be applied by any method, as long as the method does not cause any adverse impact on performances of the positive active material. For example, the method may include any coating method known in the art, for example, a spraying method and an impregnation method.

The positive active material layer further includes a binder, and optionally, includes a conductive material. The binder enhances binding between particles of the positive active material, and binding between the positive active material and the current collector.

In some embodiments, the binder includes, but is not limited to: polyvinyl alcohol, hydroxypropyl cellulose, diacetyl cellulose, polyvinyl chloride, carboxylated polyvinyl chloride, polyvinyl fluoride, a polymer containing ethylene oxide, polyvinylpyrrolidone, polyurethane, polytetrafluoroethylene, poly(vinylidene fluoride), polyethylene, polypropylene, styrene-butadiene rubber, acrylic styrene-butadiene rubber, epoxy resin, nylon, and the like.

In some embodiments, the conductive material includes, but is not limited to: a carbon-based material, a metal-based material, a conductive polymer, or a mixture thereof. In some embodiments, the carbon-based material is selected from natural graphite, artificial graphite, carbon black, acetylene black, Ketjen black, carbon fibers, or any combination thereof. In some embodiments, the metal-based material is selected from metal powder, metal fibers, copper, nickel, aluminum, or silver. In some embodiments, the conductive polymer is a polyphenylene derivative.

In some embodiments, the current collector may be, but is not limited to, aluminum.

The positive electrode may be prepared by using a preparation method known in the art. For example, the positive electrode may be obtained by using the following method: mixing an active material, a conductive material, and a binder in a solvent to prepare an active material composition, and coating a current collector with the active material composition. In some embodiments, the solvent may include, but is not limited to, N-methylpyrrolidone.

In some embodiments, the positive electrode is prepared by using a positive electrode material, which is prepared from a positive active material layer including powder of the lithium transition metal compound and the binder, on the current collector.

In some embodiments, the positive active material layer is usually prepared by the following operations: subjecting the positive active material and the binder (a conductive material, a thickener, and the like used as needed) to dry mixing to obtain a sheet, and crimping the sheet to the positive current collector; or dissolving or dispersing these materials in a liquid medium to obtain a slurry, coating the positive current collector with the slurry, and drying. In some embodiments, the material of the positive active material layer includes any material known in the art.

### 4. Separator

In some embodiments, the electrochemical apparatus according to this application has a separator disposed between the positive electrode and the negative electrode to prevent short circuit. The separator used in the electrochemical apparatus according to this application is not particularly limited to any material or shape, and may be based on any technology disclosed in the prior art. In some embodiments, the separator includes a polymer or an inorganic substance formed by a material stable to the electrolyte according to this application.

In some embodiments, the separator includes a polyolefin substrate layer and a coating on at least one surface of the polyolefin substrate layer, and a thickness ratio of the substrate layer to the coating is 1:1 to 5:1. In some embodiments, the thickness ratio of the substrate layer to the coating is 1:1, 2:1, 3:1, 4:1, 5:1, or within a range of any two of the values.

In some embodiments, the thickness of the polyolefin substrate layer is 2 µm to 10 µm. In some embodiments, the thickness of the polyolefin substrate layer is 2 µm, 3 µm, 4 µm, 5 µm, 6 µm, 7 µm, 8 µm, 9 µm, 10 µm, or within a range of any two of the values.

In some embodiments, the thickness of the coating is 0.5 µm to 3 µm. In some embodiments, the thickness of the coating is 0.5 µm, 0.7 µm, 1 µm, 1.2 µm, 1.4 µm, 1.7 µm, 2 µm, 2.5 µm, 3 µm, or within a range of any two of the values.

In some embodiments, the coating includes a polymer, and the polymer includes at least one of the following compounds: polytetrafluoroethylene, polyvinylidene fluoride, a tetrafluoroethylene-perfluorinated alkyl vinyl ether copolymer, an ethylene-tetrafluoroethylene copolymer, an ethylene-chlorotrifluoroethylene copolymer, a perfluorinated ethylene-propylene copolymer, acrylic acid, methacrylic acid, itaconic acid, ethyl acrylate, butyl acrylate, acrylonitrile, or methacrylonitrile.

In some embodiments, the coating includes inorganic particles, and the inorganic particles include at least one of the following compounds: aluminum oxide, silicon dioxide, magnesium oxide, titanium oxide, hafnium dioxide, tin oxide, ceria oxide, nickel oxide, zinc oxide, calcium oxide, zirconium oxide, yttrium oxide, silicon carbide, boehmite, aluminum hydroxide, magnesium hydroxide, calcium hydroxide, or barium sulfate.

In some embodiments, the coating includes both the polymer and the inorganic particles defined above.

In some embodiments, the polyolefin substrate layer is polyethylene, polypropylene, an ethylene-propylene copolymer, or any combination thereof.

In some embodiments, the separator is a single-layer PE (polyethylene) porous polymer film.

In some embodiments, the separator is a low-temperature shutdown separator. In some embodiments, the low-temperature shutdown separator includes two first layers and a second layer arranged between the two first layers.

In some embodiments, the first layers and the second layer each are independently includes a polyolefin substrate layer and a coating on at least one surface of the polyolefin substrate layer. In some embodiments, definitions of the polyolefin substrate layer and the coating are as described above.

In some embodiments, a shutdown temperature of the first porous layers is 120° C. to 140° C. In some embodiments, the shutdown temperature of the first porous layers is 120° C., 125° C., 130° C., 135° C., 140° C., or within a range of any two of the values.

### IV. Application

The electrolyte according to the embodiments of this application can control the cyclic swelling, and improve the high-temperature performance, overcharge performance, and hot-box testing performance of a battery, and is applicable to an electronic apparatus including an electrochemical apparatus.

The electrochemical apparatus according to this application is not particularly limited to any purpose, and may be used for any known purposes. For example, the electrochemical apparatus may be used for a notebook computer, a pen-input computer, a mobile computer, an electronic book player, a portable telephone, a portable fax machine, a portable copier, a portable printer, a headset, a video recorder, a liquid crystal television, a portable cleaner, a portable CD player, a mini-disc, a transceiver, an electronic notebook, a calculator, a storage card, a portable recorder, a radio, a standby power source, a motor, an automobile, a motorcycle, a motor bicycle, a bicycle, a lighting appliance, a toy, a game console, a clock, an electric tool, a flash lamp, a camera, a large household battery, a lithium ion capacitor, or the like.

By taking a lithium-ion battery as an example, the following describes the preparation and performance of the lithium-ion battery according to this application with reference to specific embodiments of preparing the electrolyte according to this application and test modes of the electrochemical apparatus. Those skilled in the art will understand that a preparation method described in this application is only an example, and any other appropriate preparation methods are within the scope of this application.

Although the lithium-ion battery is used as an example, after reading this application, those skilled in the art can figure out that the positive electrode material according to this application can be applied to other appropriate electrochemical apparatuses. Such an electrochemical apparatus includes any apparatus in which an electrochemical reaction takes place. Specific examples of the apparatus include all types of primary batteries, secondary batteries, fuel batteries, solar batteries, or capacitors. Especially, the electrochemical apparatus is a lithium secondary battery, including a lithium metal secondary battery, a lithium-ion secondary battery, a lithium polymer secondary battery, or a lithium-ion polymer secondary battery.

### EXAMPLES

This application will be further specifically described below with examples and comparative examples, and this application is not limited to these examples as long as the essence of this application is not changed.

### 1. Preparation of a Lithium-ion Battery

### 1) Preparation of an Electrolyte

In an glove box under argon atmosphere with water content less than 10 ppm, ethylene carbonate (EC for short), propylene carbonate (PC for short), and diethyl carbonate (DEC for short) were mixed evenly at a weight ratio of 3:3:4 to obtain a solvent, and a lithium salt LiPF₆ dried fully was dissolved in the solvent to obtain a basic electrolyte, where a concentration of LiPF₆ in the basic electrolyte was 1 mol/L. Substances with different content, as shown in the tables below, were added into the basic electrolyte, to obtain electrolytes in different examples and comparative examples. The content of each substance in electrolytes described below was calculated based on the total weight of the electrolyte.

Examples of a compound of formula I were as follows:

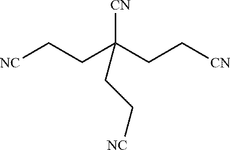

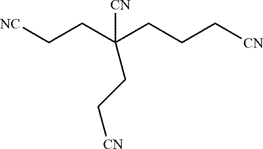

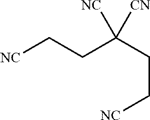

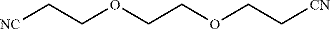

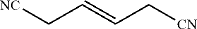

, and

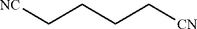

Examples of a compound containing sulfur-oxygen double bonds were as follows:

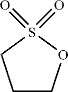

, and

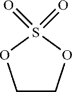

Examples of a lithium phosphate compound were shown below: lithium difluorophosphate (LiPO₂F₂) and Lithium tetrafluoro(oxalato)phosphate (LiTFOP).

### 2) Preparation of a Positive Electrode

Five different types of positive electrodes were used in the examples of this application. Preparation methods were shown below:

Positive electrode 1: A positive active substance LCO (with a molecular formula of LiCo_{0.998}Mg_{0.002}O₂), conductive carbon black, and polyvinylidene fluoride (PVDF for short) were fully stirred and mixed in an appropriate amount of N-methylpyrrolidone (NMP for short) solvent at a weight ratio of 97:1:2, to form a uniform positive electrode slurry; and the slurry was coated onto Al foil of a positive current collector, followed by drying and cold pressing, to obtain a positive electrode, where a compaction density of the positive electrode was 4.15 g/cm³.

Positive electrode 2: A positive active substance NCM811 (with a molecular formula of LiNi_{0.8}Mn_{0.098}Co_{0.1}Mg_{0.002}O₂), a conductive agent acetylene black, and a binder polyvinylidene fluoride (PVDF for short) were fully stirred and mixed in an appropriate amount of N-methylpyrrolidone (NMP for short) solvent at a weight ratio of 96:2:2, to form a uniform positive electrode slurry; and the slurry was coated onto Al foil of a positive current collector, followed by drying and cold pressing, to obtain a positive electrode, where a compaction density of the positive electrode was 3.50 g/cm³.

Positive electrode 3: A positive active substance NCM523 (with a molecular formula of LiNi_{0.5}Mn_{0.298}Co_{0.2}Mg_{0.002}O₂), conductive carbon black-L, and a binder polyvinylidene fluoride were fully stirred and mixed in an appropriate amount of N-methylpyrrolidone (NMP for short) solvent at a weight ratio of 96:2:2, to form a uniform positive electrode slurry; and the slurry was coated onto Al foil of a positive current collector, followed by drying and cold pressing, to obtain a positive electrode, where a compaction density of the positive electrode was 3.50 g/cm³.

Positive electrode 4: The preparation method of positive electrode 4 was similar to that of positive electrode 1, and the differencewas that the positive active was LiCoO₂.

Positive electrode 5: The preparation method of positive electrode 5 was similar to that of positive electrode 1, and in the different was that the positive active was LiCo_{0.996}Mg_{0.002}Al_{0.001}Ti_{0.001}O₂.

### 3) Preparation of a Negative Electrode

Three different types of negative electrodes were used in the examples of this application. Preparation methods were shown below:

Negative electrode 1: A negative active substance graphite, a binder styrene-butadiene rubber (SBR for short), and sodium carboxymethyl cellulose (CMC-Na for short) were fully stirred and mixed in an appropriate amount of deionized water solvent at a weight ratio of 97.4: 1.4: 1.2, to form a uniform negative electrode slurry; and the slurry was coated onto Cu foil of a negative current collector, followed by drying and cold pressing, to obtain a negative electrode, where a compaction density of the negative electrode was 1.80 g/cm³.

Negative electrode 2: A negative active substance graphite, a silicon-oxygen material (SiO), sodium carboxymethyl cellulose (CMC-Na for short), and modified polyacrylic acid were fully stirred and mixed in an appropriate amount of deionized water solvent at a weight ratio of 87:10:0.6:2.4, to form a uniform negative electrode slurry; and the slurry was coated onto Cu foil of a negative current collector, followed by drying and cold pressing, to obtain a negative electrode, where a compaction density of the negative electrode was 1.70 g/cm³.

Negative electrode 3: The preparation method of negative electrode 3 was similar to that of negative electrode 2, and the different was that an aluminum oxide layer arranged on the surface of the silicon-oxygen material, and a thickness of the aluminum oxide layer was 5 nm.

Negative electrode 4: The preparation method of negative electrode 4 was similar to that of negative electrode 2, and the difference was that a carbon layer was arranged on the surface of the silicon-oxygen material, and a thickness of the carbon layer was 5 nm.

### 4) Separator

Four different types of separators were used in the examples of this application. Components of the separators were shown below, where separators LTS-1, LTS-2, and LTS-3 were low-temperature shutdown separators:

Separator S: A single-layer polyethylene (PE) porous polymer film was used as a separator, with a thickness of 9 µm and a porosity of 39%, both surfaces of the polyethylene (PE) porous polymer film were provided with coatings, an average thickness of the coatings is 1.5 µm, where inorganic particles of the coatings were Al₂O₃, and the polymer referred to polyvinylidene fluoride.

Separator LTS-1: Separator LTS-1 was a three-layer composite film, that is, a second porous layer was arranged between two first porous layers; the first porous layers were films prepared from a mixture of polypropylene (PP) and PE, where a number-average molecular weight of PE was 5.0×10³ to 4.0×10⁵, a number-average molecular weight of PP was 1.0×10⁵ to 9.0×10⁵, and the content of PP was 1 wt% to 3 wt%; the second porous layer was PE, and a number-average molecular weight thereof was 1.0×10⁵ to 9.0×10⁵; a thickness of each first porous layer was 4 µm, a thickness of the second porous layer was 4 µm, coatings were arranged on the surfaces, away from the second porous layer, of the two first porous layers, an average thickness of the coatings was 1.5 µm, inorganic particles on the coatings were Al₂O₃, the polymer was polyvinylidene fluoride, and a shutdown temperature of the first porous layers was 131±2° C.

Separator LTS-2: Separator LTS-2 was a three-layer composite film, that is, a second porous layer was arranged between two first porous layers; the first porous layers were PE with a low molecular weight, and a number-average molecular weight thereof was 5.0×10³ to 4.0×10⁵; the second porous layer was PE with a high molecular weight, and a number-average molecular weight thereof was 9.0×10⁵ to 4.0×10⁶; a thickness of each first porous layer was 4 µm, and a thickness of the second porous layer was 4 µm; coatings were arranged on the surfaces, away from the second porous layer, of the two first porous layers, an average thickness of the coatings was 1.5 µm, inorganic particles on the coatings were magnesium hydroxide, the polymer was polyvinylidene fluoride, and a shutdown temperature of the first porous layers was 129±2° C.

Separator LTS-3: Separator LTS-3 was a three-layer composite film, that is, a second porous layer was arranged between two first porous layers; the first porous layers were PE with a low molecular weight, and a number-average molecular weight thereof was 5.0×10³ to 4.0×10⁵; the second porous layer was a PP-PE copolymer, where the content of PE was 7 wt% to 15 wt%, and a number-average molecular weight thereof was 1.0×10⁵ to 9.0×10⁵; a thickness of each first porous layer was 4 µm, and a thickness of the second porous layer was 4 µm; coatings were arranged on the surfaces, away from the second porous layer, of the two first porous layers, an average thickness of the coatings was 1.5 µm, inorganic particles on the coatings were boehmite, the polymer was polyvinylidene fluoride, and a shutdown temperature of the first porous layers was 129±2° C.

5) Preparation of a lithium-ion battery: A positive electrode, a separator, and a negative electrode were laminated in order, so that the separator was located between the positive electrode and the negative electrode for isolation, followed by winding, and placing in outer packaging foil; the prepared electrolyte was injected into a dried battery to complete the preparation of the lithium-ion battery after processes such as vacuum packaging, standing, chemical conversion, and shaping.

### 2. Performance Test Methods of the Lithium-ion Battery

A. Electrolytes and lithium-ion batteries in Examples 1 to 31 and Comparative Examples 1 to 4 were prepared according to the above preparation methods, where the positive electrode was positive electrode 1 (with the active substance LCO), the separator was separator S, and the negative electrode was negative electrode 1 (with the active substance graphite). The content of each substance in the electrolytes and related performance test results of the lithium-ion batteries were shown in Table 1, and preparation methods were as follows:

(1) Cycle performance test process: At 25° C., a battery was charged to 4.45 V at 1.5 C, charged to 0.05 C at a constant voltage of 4.45 V, and then discharged to 3.0 V at a current of 1 C, and a thickness of the lithium-ion battery was tested and denoted as d0; and a process of charging at 1.5 C and discharging at 1 C was repeated in 800 cycles, followed by thickness measuring, and a measured thickness was denoted as d. Cyclic swelling rate was calculated according to the following formula: Swelling rate(%) = (d-d0)/d0 × 100%.

(2) Hot-box testing process: A battery was charged to 4.45 V at a constant current of 0.5 C, charged to 0.05 C at a constant voltage of 4.45 V, and subjected to standing at 25±5° C. for 60 min, followed by visual inspection and photographing; a rate of 5° C./min±2° C./min was increased to 130° C.±2° C. and then held for 120 min; after the test, visual inspection and photographing were performed, voltage and temperature in the test process were monitored, and the battery passed the test if there was no fire or explosion. Ten batteries were tested in parallel in each example and each comparative example, and the number of the batteries that passed the test was recorded.

(3) High-temperature storage test process: At 25° C., a battery was charged to 4.45 V at a constant current of 0.5 C and then charged to 0.05 C at a constant voltage, and a thickness of the lithium-ion battery was measured and denoted as d1; the battery was placed in an oven at 85° C. for 24 h, and then the thickness of the battery was measured and denoted as d2. A thickness swelling rate (%) of the lithium-ion battery after high-temperature storage for 24 h was equal to (d2-d1)/d1 × 100%. The batteries using positive electrodes 1, positive electrodes 3, positive electrodes 4, and positive electrodes 5 were charged to 4.45 V in the high-temperature storage test; the battery using positive electrode 2 was charged to 4.25 V in the high-temperature storage test; and other test processes were not changed.

TABLE 1

| No. | Compound of formula I | | | | | | Compound containing sulfur-oxygen double bonds | | Cyclic swelling rate (%) | High-temperature storage thickness swelling rate (%) at 85° C. | Pass quantity of hot-box test |
|---|---|---|---|---|---|---|---|---|---|---|---|
| | I-1 | I-2 | A | B | C | D | II-11 | II-16 | | | |
| | wt % | wt % | wt % | wt % | wt % | wt % | wt% | wt% | | | |
| Example 1 | 3 | — | — | — | — | — | — | — | 14.2 | 17.6 | 6 |
| Example 2 | — | 3 | — | — | — | — | — | — | 14.8 | 16.9 | 7 |
| Example 3 | 2 | — | — | — | — | — | — | — | 14.9 | 17.9 | 6 |
| Example 4 | 1 | — | — | — | — | — | — | — | 14.7 | 18.5 | 5 |
| Example 5 | 0.5 | — | — | — | — | — | — | — | 15.7 | 19.0 | 4 |
| Example 6 | 0.1 | — | — | — | — | — | — | — | 16.0 | 20.1 | 4 |
| Example 7 | 5 | — | — | — | — | — | — | — | 16.3 | 15.2 | 8 |
| Example 8 | 3 | — | — | 1 | — | — | 4 | — | 10.23 | 13.5 | 10 |
| Example 9 | — | 3 | — | 1 | — | — | 4 | — | 10.15 | 11.6 | 10 |
| Example 10 | 1 | — | — | 1 | — | — | — | — | 14.02 | 18.2 | 6 |
| Example 11 | 1 | — | — | — | — | — | 4 | — | 12.75 | 16.1 | 7 |
| Example 12 | 1 | — | — | 1 | — | — | 4 | — | 12.02 | 15.6 | 7 |
| Example 13 | 0.1 | — | — | — | 3 | — | 4 | — | 12.95 | 18.8 | 5 |
| Example 14 | 0.5 | — | — | — | — | 3 | 4 | — | 12.63 | 18.2 | 5 |
| Example 15 | 2 | — | — | 1 | — | — | 4 | — | 10.56 | 12.1 | 9 |
| Example 16 | 2 | — | — | — | 1 | — | 4 | — | 10.92 | 12.5 | 9 |
| Example 17 | 2 | — | — | — | — | 1 | 4 | — | 10.83 | 12.3 | 9 |
| Example 18 | 2 | — | — | 1 | — | — | 3 | 1 | 11.65 | 13.6 | 7 |
| Example 19 | — | 2 | — | — | — | 1 | 3 | 1 | 11.17 | 14.2 | 7 |
| Example 20 | 2 | — | — | 1 | — | — | 3 | 1 | 11.61 | 13.5 | 7 |
| Example 21 | 1 | — | — | 2 | — | — | 4 | 1 | 11.82 | 15.8 | 7 |
| Example 22 | 1 | — | — | — | — | 2 | 4 | 1 | 11.87 | 16.3 | 7 |
| Example 23 | 2 | — | — | 1 | — | — | — | 4 | 12.16 | 14.3 | 6 |
| Example 24 | 2 | — | — | 1 | — | — | — | 3 | 12.27 | 14.5 | 6 |
| Example 25 | 3 | — | — | 1 | — | — | 4 | 1 | 8.37 | 8.9 | 10 |
| Example 26 | 2 | — | — | 1 | — | 1 | 4 | — | 9.92 | 11.7 | 10 |
| Example 27 | 2 | — | — | 1 | — | 1 | 4 | 1 | 9.90 | 11.6 | 10 |
| Example 28 | — | 2 | — | 1 | — | 1 | 4 | 1 | 9.55 | 11.2 | 10 |
| Example 29 | 2 | — | — | 1 | — | 1 | — | 3 | 12.05 | 11.1 | 7 |
| Example 30 | 2 | 1 | — | 1 | — | — | 4 | 1 | 8.23 | 8.7 | 10 |
| Example 31 | 5 | — | — | — | — | — | 4 | — | 14.15 | 13.1 | 10 |
| Comparative Example 1 | — | — | — | — | — | — | 4 | — | 16.6 | 25.3 | 0 |
| Comparative Example 2 | — | — | — | — | — | — | — | 4 | 17.8 | 27.1 | 0 |
| Comparative Example 3 | — | — | 3 | — | — | — | 4 | — | 14.60 | 14.5 | 6 |
| Comparative Example 4 | — | — | — | 1 | — | — | 4 | — | 16.1 | 24.6 | 1 |

“—” indicates that the substance is not added.

It could be seen from the examples and comparative examples in Table 1 that adding the compound of formula I into the electrolyte could significantly control the cyclic swelling and improve the high-temperature storage performance and hot-box test performance of the lithium-ion battery.

In addition, it could be seen that adding the compound containing sulfur-oxygen double bonds to the electrolyte containing the compound of formula I could further control the cyclic swelling and improve the high-temperature storage performance and hot-box test performance of the lithium-ion battery.

B. Electrolytes and lithium-ion batteries in Examples 32 to 42 and Comparative Examples 5 to 6 were prepared according to the above preparation methods, and the batteries were subjected to the high-temperature storage test; the separator was separator S, and the negative electrode was negative electrode 1 (with the active substance graphite). Table 2 showed the content of each substance in the electrolytes, types of the positive electrodes, and related performance test results of Examples 32 to 42 and Comparative Examples 5 and 6.

TABLE 2

| No. | Type of positive electrode | Compound of formula I | | Compound containing sulfur-oxygen double bonds | | High-temperature storage thickness swelling rate at 85° C. |
|---|---|---|---|---|---|---|
| | | I-1 | I-2 | II-11 | II-16 | |
| | | wt% | wt% | wt% | wt% | |
| Example 32 | Positive electrode 2 | 3 | — | 2 | — | 15.2% |
| Example 33 | Positive electrode 2 | — | 3 | 2 | — | 13.8% |
| Example 34 | Positive electrode 2 | 3 | — | 2 | 0.5 | 14.3% |
| Example 35 | Positive electrode 2 | 3 | — | 3 | 0.5 | 13.6% |
| Example 36 | Positive electrode 3 | 3 | — | 4 | 1 | 18.9% |
| Example 37 | Positive electrode 3 | — | 3 | 4 | 1 | 18.2% |
| Example 38 | Positive electrode 3 | 3 | — | 5 | 1 | 16.7% |
| Example 39 | Positive electrode 3 | 3 | — | 3 | 2 | 19.9% |
| Example 40 | Positive electrode 1 | 3 | — | 2 | — | 11.7% |
| Example 41 | Positive electrode 4 | 3 | — | 2 | — | 15.9% |
| Example 42 | Positive electrode 5 | 3 | — | 2 | — | 10.6% |
| Comparative Example 5 | Positive electrode 2 | — | — | 2 | — | 25.5% |
| Comparative Example 6 | Positive electrode 3 | — | — | 4 | 1 | 21.6% |

“—” indicates that the substance is not added.

It could be seen from the performance test results of the examples and the comparative examples in Table 2 that, in the lithium-ion battery using positive electrode 2 (with the active substance NCM811) or positive electrode 3 (with the active substance NCM523), compared with the electrolyte using the compound of formula I-1, the electrolyte using the compound of formula I-2 could further improve the high-temperature storage performance of the lithium-ion battery. When the same electrolyte was used, the high-temperature storage performance of the lithium-ion battery could be further improved by using positive electrode 2 (with the active substance NCM811) and positive electrode 3, compared with that by using positive electrode 1.

C. Electrolytes and lithium-ion batteries in Examples 43 to 50 and Example 1 were prepared by the above preparation methods, where the positive electrode was positive electrode 1, the separator was separator S, the negative electrode was negative electrode 1 (with the active substance graphite), and the batteries were subjected to the high-temperature storage test.

Table 3 showed the content of each substance in the electrolytes and related performance test results of Examples 43 to 50 and Example 1.

TABLE 3

| No. | Compound of formula I | Compound containing sulfur-oxygen double bonds | | Lithium phosphate compound | | High-temperature storage thickness swelling rate at 85° C. |
|---|---|---|---|---|---|---|
| | I-1 | II-11 | II-16 | LiPO₂F₂ | LiTFOP | |
| | wt% | wt% | wt% | wt% | wt% | % |
| Example 1 | 3 | — | — | — | — | 17.6 |
| Example 43 | 3 | 3 | — | — | — | 15.1 |
| Example 44 | 3 | — | — | 0.5 | — | 15.9 |
| Example 45 | 3 | — | — | 0.1 | — | 16.7 |
| Example 46 | 3 | 3 | | 0.5 | | 14.6 |
| Example 47 | 3 | 3 | 0.5 | 0.2 | — | 13.0 |
| Example 48 | 3 | 3 | 0.5 | 0.3 | — | 12.5 |
| Example 49 | 3 | 3 | 0.5 | 0.5 | — | 10.7 |
| Example 50 | 3 | 3 | 0.5 | — | 0.5 | 11.6 |

“—” indicates that the substance is not added.

It could be seen from the test results in Table 3 that the high-temperature storage performance of the lithium-ion battery could be further improved by adding the lithium phosphate compound into the electrolyte containing the compound of formula I and the compound containing sulfur-oxygen double bonds. The reason might be that lithium difluorophosphate (LiPO₂F₂) and lithium tetrafluorooxalatephosphate (LiTFOP) could reduce the contact between the electrolyte and the positive electrode to inhibit the gassing.

D. Electrolytes and lithium-ion batteries in Examples 51A to 59B were prepared by the above preparation methods, where the positive electrode was positive electrode 2 (with the active substance NCM811), the negative electrode was negative electrode 1 (with the active substance graphite), and types of the separator were shown in Table 4. The lithium-ion batteries in the examples were subjected to an overcharge test, and the test process was as follows. The electrolytes in Examples 51A and 51B, as well as in Examples 58A and 58B, and Examples 59A and 59B, were the same, but the overcharge test to the lithium-ion batteries were carried out on different conditions.

Overcharge test process: At 25° C., a battery was discharged to 2.8 V at a current of 0.5 C, charged to different voltages shown in Table 4 at a constant current of 2 C (4 A), and then was charged at a constant voltage for 3 hours; changes of surface temperature of the battery were monitored; the battery passed the test if there was no fire or smoke; 10 batteries were tested in each example, and the number of the batteries that passed the test was calculated.

The content of each substance in the electrolytes and related test results of Examples 51A to 59B were shown in Table 4.

TABLE 4

| No. | Type of separator | Compound of formula I | | Overcharge test | |
|---|---|---|---|---|---|
| | | I-1 | I-2 | Voltage | Pass quantity |
| | | wt% | wt% | | |
| Example 51-A | LTS-2 | 1 | — | 10 V | 10 |
| Example 51-B | LTS-2 | 1 | — | 11 V | 3 |
| Example 52 | LTS-2 | 3 | — | 11 V | 6 |
| Example 53 | LTS-2 | 5 | — | 11 V | 8 |
| Example 54 | LTS-2 | — | 3 | 11 V | 9 |
| Example 55 | LTS-1 | 3 | — | 10 V | 5 |
| Example 56 | LTS-1 | — | 3 | 10 V | 9 |
| Example 57 | LTS-3 | 3 | — | 10 V | 9 |
| Example 58-A | LTS-3 | — | 3 | 10 V | 10 |
| Example 58-B | LTS-3 | — | 3 | 11 V | 3 |
| Example 59-A | S | 3 | — | 7 V | 9 |
| Example 59-B | S | 3 | — | 8 V | 0 |

“—” indicates that the substance is not added.

It could be seen from the test results in Table 4 that the battery using separator S in Example 59-B failed the overcharge test under 8 V. In the case of using the same electrolyte, the overcharge performance of the lithium-ion battery was significantly improved after separator S was replaced with the low-temperature shutdown separator (LTS-1, LTS-2 or LTS-3). The reason might be that a synergistic effect was achieved by combination of the compound of formula I and the low-temperature shutdown separator, and a compound containing cyano groups could improve interface stability of the positive electrode material, thereby reducing decomposition of the electrolyte on the electrode surface during the overcharge process and the hot-box process, and slowing down the temperature rise. When the temperature was increased to achieve shutdown of the separator, lithium ion transmission could be inhibited, thereby preventing continued charging. Since shutdown at a low temperature could be achieved by using the low-temperature shutdown separator, thermal runaway was prevented, and overcharge and hot-box performances were improved.

E. Electrolytes and lithium-ion batteries in Examples 60 to 64 and Comparative Examples 7 and 8 were prepared by the above preparation methods, where the positive electrode was positive electrode 1, the separator was separator S, and the batteries were subjected to the high-temperature storage test.

60° C. high-temperature storage test process: At 25° C., a battery was charged to 4.45 V at a constant current of 0.5 C and then charged to a current of 0.05 C at a constant voltage, and a thickness of the lithium-ion battery was measured and denoted as d₀; the battery was placed in an oven at 60° C. for 30 days, and then the thickness was measured and denoted as d. Thickness swelling rate (%) of the lithium-ion battery after high-temperature storage for 24 h = (d-d₀)/d₀ × 100%.

Components of various substances in the electrolytes, types of the negative electrodes and related performance test results of Examples 60 to 64 and Comparative Examples 7 and 8 were shown in Table 5.

TABLE 5

| No. | Type of negative electrode | Compound of formula I | | High-temperature storage thickness swelling rate at 60° C. |
|---|---|---|---|---|
| | | I-1 | I-2 | |
| | | wt% | wt% | |
| Example 60 | Negative electrode 2 | 3 | — | 15.6% |
| Example 61 | Negative electrode 2 | — | 3 | 14.2% |
| Example 62 | Negative electrode 3 | 3 | — | 12.6% |
| Example 63 | Negative electrode 3 | — | 3 | 10.5% |
| Example 64 | Negative electrode 4 | 3 | — | 12.4% |
| Comparative Example 7 | Negative electrode 2 | — | — | 100% |
| Comparative Example 8 | Negative electrode 3 | — | — | 100% |

“—” indicates that the substance is not added.

It could be seen from the test results in Table 5 that the high-temperature storage performance of the lithium-ion battery could be improved significantly by adding the compound containing cyano functional group into the electrolytes in Comparative Examples 7 and 8. The reason might be that the compound of formula I could improve the interface stability of the positive electrode material while inhibiting dissolution of transition metals and reducing deposition of Co on the surface of the negative electrode, thereby slowing down decomposition of a solid electrolyte interface (SEI). Under coaction of the compounds, decomposition of the electrolyte was reduced, the gassing was inhibited, and the high-temperature storage performance was improved.

References to “some embodiments”, “an embodiment”, “another example”, “examples”, “specific examples”, or “some examples” in the specification mean the inclusion of specific features, structures, materials, or characteristics described in the embodiment or example in at least one embodiment or example of this application. Accordingly, descriptions appearing in the specification, such as “in some embodiments”, “in the embodiments”, “in an embodiment”, “in another example”, “in an example”, “in a particular example”, or “for example”, are not necessarily references to the same embodiments or examples in this application. In addition, specific features, structures, materials, or characteristics herein may be incorporated in any suitable manner into one or more embodiments or examples.

Although illustrative embodiments have been demonstrated and described, those skilled in the art should understand that the above embodiments are not to be construed as limiting this application, and that the embodiments may be changed, replaced, and modified without departing from the spirit, principle, and scope of this application.

1. An electrolyte, comprising: a compound of formula I 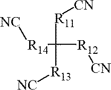
wherein R₁₁ is selected from a covalent bond, a substituted or unsubstituted C₁-C₂₀ alkylidene group, a substituted or unsubstituted C₂-C₂₀ alkenylene group, a substituted or unsubstituted C₂-C₂₀ alkynylene group, a substituted or unsubstituted C₆-C₂₀ arylene group, a substituted or unsubstituted C₃-C₂₀ heteroarylene group, a substituted or unsubstituted C₃-C₂₀ cycloalkylene group, 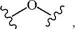 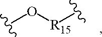 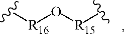
or a combination thereof;
wherein R₁₂, R₁₃, and R₁₄ are each independently selected from a substituted or unsubstituted C₁-C₂₀ alkylidene group, a substituted or unsubstituted C₂-C₂₀ alkenylene group, a substituted or unsubstituted C₂-C₂₀ alkynylene group, a substituted or unsubstituted C₆-C₂₀ arylene group, a substituted or unsubstituted C₃-C₂₀ heteroarylene group, a substituted or unsubstituted C₃-C₂₀ cycloalkylene group, 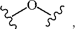 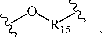 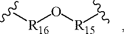
or a combination thereof;
wherein R₁₅ and R₁₆ are each independently selected from a C₁-C₂₀ alkylidene group, a substituted or unsubstituted C₂-C₂₀ alkenylene group, a substituted or unsubstituted C₂-C₂₀ alkynylene group, a substituted or unsubstituted C₆-C₂₀ arylene group, a substituted or unsubstituted C₃-C₂₀ heteroarylene group, or a substituted or unsubstituted C₃-C₂₀ cycloalkylene group;
wherein when the groups are substituted, substituents each are selected from halogen, a C₁-C₂₀ alkyl group, a C₃-C₂₀ cycloalkyl group, a C₂-C₂₀ alkenyl group, a C₆-C₂₀ aryl group, or a C₃-C₂₀ heteroaryl group; and
wherein the heteroatom is selected from one or more of O, S, N, and P.

2. The electrolyte according to claim 1, wherein the compound of formula I comprises at least one of the following compounds: 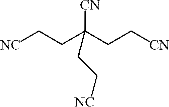 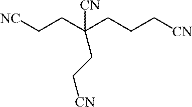 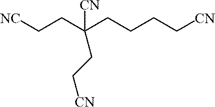 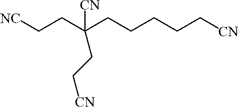 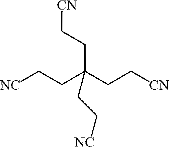 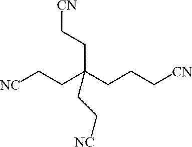 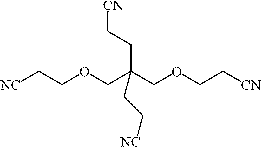 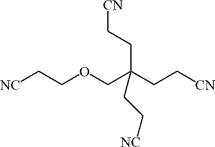 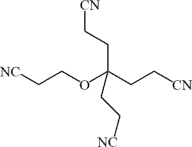 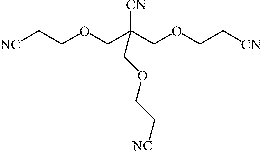 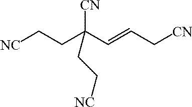 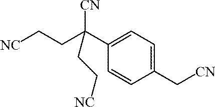 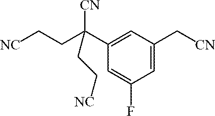 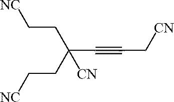 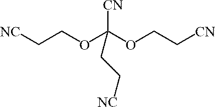 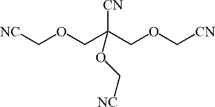
or 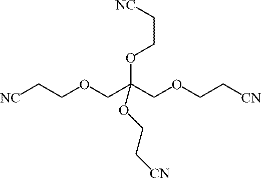
, and
wherein based on a total weight of the electrolyte, a content of the compound of formula I is 0.01 wt% to 5 wt%.

3. The electrolyte according to claim 1, further comprising a compound containing sulfur-oxygen double bonds, and the compound containing sulfur-oxygen double bonds comprises a compound of formula (II-A), a compound of formula (II-B), or a combination of the compounds: 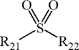
, and 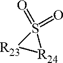
wherein R₂₁ and R₂₂ are each independently selected from a substituted or unsubstituted C₁-C₂₀ alkyl group, a substituted or unsubstituted C₂-C₂₀ alkenyl group, a substituted or unsubstituted C₂-C₂₀ alkynyl group, a substituted or unsubstituted C₆-C₂₀ aryl group, a substituted or unsubstituted C₃-C₂₀ heteroaryl group, a substituted or unsubstituted C₃-C₂₀ cycloalkyl group, —O—R₂₅, or —R₂₆—O—R₂₇;
wherein R₂₅ and R₂₇ are each independently selected from a substituted or unsubstituted C₁-C₂₀ alkyl group, a substituted or unsubstituted C₂-C₂₀ alkenyl group, a substituted or unsubstituted C₂-C₂₀ alkynyl group, a substituted or unsubstituted C₆-C₂₀ aryl group, a substituted or unsubstituted C₃-C₂₀ heteroaryl group, or a substituted or unsubstituted C₃-C₂₀ cycloalkyl group;
wherein R₂₆ is selected from a substituted or unsubstituted C₁-C₂₀ alkylidene group, a substituted or unsubstituted C₂-C₂₀ alkenylene group, a substituted or unsubstituted C₂-C₂₀ alkynylene group, a substituted or unsubstituted C₆-C₂₀ arylene group, a substituted or unsubstituted C₃-C₂₀ heteroarylene group, or a substituted or unsubstituted C₃-C₂₀ cycloalkylene group;
wherein R₂₃ and R₂₄ are each independently selected from a substituted or unsubstituted C₁-C₂₀ alkylidene group, a substituted or unsubstituted C₂-C₂₀ alkenylene group, a substituted or unsubstituted C₂-C₂₀ alkynylene group, a substituted or unsubstituted C₆-C₂₀ arylene group, a substituted or unsubstituted C₃-C₂₀ heteroarylene group, 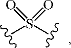 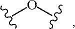
—O—R′—, —R′—O—R″—, or a combination thereof;
wherein R′ and R″ are each independently selected from a substituted or unsubstituted C₁-C₂₀ alkylidene group, a substituted or unsubstituted C₂-C₂₀ alkenylene group, or a substituted or unsubstituted C₂-C₂₀ alkynylene group;
wherein when the groups are substituted, substituents each are independently selected from halogen, a cyano group, a C₁-C₂₀ alkyl group, a C₃-C₂₀ cycloalkyl group, a C₂-C₂₀ alkenyl group, a C₆-C₂₀ aryl group, or a C₆-C₂₀ heteroaryl group;
wherein the heteroatom is selected from one or more of O, S, N, and P; and
wherein based on the total weight of the electrolyte, a content of the compound containing sulfur-oxygen double bonds is 0.01 wt% to 10 wt%.

4. The electrolyte according to claim 3, wherein the compound containing sulfur-oxygen double bonds comprises at least one of the following compounds: 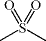 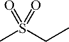 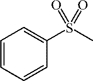 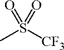 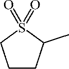 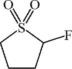 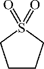 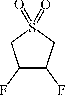 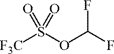 [SMILES: O=S(=O)(OC(F)F)C(F)(F)F] 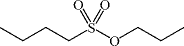 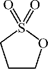 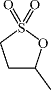 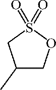 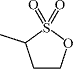 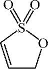 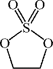 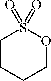 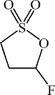 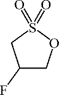 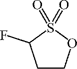
or 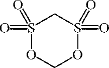
.

5. The electrolyte according to claim 1, further comprising a cyclic carbonate compound comprising a compound of formula III: 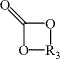
wherein R₃ is selected from a substituted or unsubstituted C₁-C₂₀ alkylidene group, or a substituted or unsubstituted C₂-C₂₀ alkenylene group; and
wherein when R₃ is substituted, a substituent is selected from halogen, a C₁-C₆ alkyl group, a C₂-C₆ alkenyl group, a C₆-C₂₀ aryl group, or a C₆-C₂₀ heteroaryl group, wherein the heteroatom is selected from one or more of O, S, N, and P.

6. The electrolyte according to claim 5, wherein based on a total weight of the electrolyte, a content of the cyclic carbonate compound is 0.01 wt% to 40 wt%.

7. The electrolyte according to claim 5, wherein the cyclic carbonate compound comprises at least one of the following compounds: 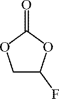 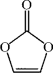 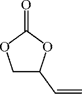 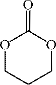 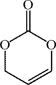 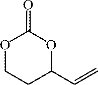 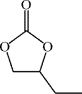
, and 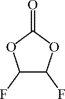
.

8. An electrochemical apparatus, comprising a positive electrode, a negative electrode, a separator and an electrolyte, the electrolyte comprising a compound of formula I: 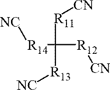
wherein R₁₁ is selected from a covalent bond, a substituted or unsubstituted C₁-C₂₀ alkylidene group, a substituted or unsubstituted C₂-C₂₀ alkenylene group, a substituted or unsubstituted C₂-C₂₀ alkynylene group, a substituted or unsubstituted C₆-C₂₀ arylene group, a substituted or unsubstituted C₃-C₂₀ heteroarylene group, a substituted or unsubstituted C₃-C₂₀ cycloalkylene group, 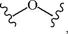 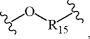 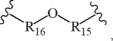
or a combination thereof;
wherein R₁₂, R₁₃, and R₁₄ are each independently selected from a substituted or unsubstituted C₁-C₂₀ alkylidene group, a substituted or unsubstituted C₂-C₂₀ alkenylene group, a substituted or unsubstituted C₂-C₂₀ alkynylene group, a substituted or unsubstituted C₆-C₂₀ arylene group, a substituted or unsubstituted C₃-C₂₀ heteroarylene group, a substituted or unsubstituted C₃-C₂₀ cycloalkylene group, 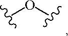 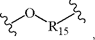 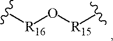
or a combination thereof;
wherein R₁₅ and R₁₆ are each independently selected from a C₁-C₂₀ alkylidene group, a substituted or unsubstituted C₂-C₂₀ alkenylene group, a substituted or unsubstituted C₂-C₂₀ alkynylene group, a substituted or unsubstituted C₆-C₂₀ arylene group, a substituted or unsubstituted C₃-C₂₀ heteroarylene group, or a substituted or unsubstituted C₃-C₂₀ cycloalkylene group;
wherein when the groups are substituted, substituents each are selected from halogen, a C₁-C₂₀ alkyl group, a C₃-C₂₀ cycloalkyl group, a C₂-C₂₀ alkenyl group, a C₆-C₂₀ aryl group, or a C₃-C₂₀ heteroaryl group;and
wherein the heteroatom is selected from one or more of O, S, N, and P.

9. The electrochemical apparatus according to claim 8, wherein the positive electrode comprises a current collector and a positive active material layer on the current collector, and the positive active material layer comprises a positive active material, wherein the positive active material comprises an element A, the element A comprises at least one of Mg, Ti, Zr, Y, Zn, La, Al, W, or Si, and based on a total weight of the positive active material, the content of the element A is 50 ppm to 8000 ppm.

10. The electrochemical apparatus according to claim 8, wherein the separator comprises a polyolefin substrate layer and a coating on at least one surface of the polyolefin substrate layer, and a thickness ratio of the substrate layer to the coating is 1:1 to 5:1.

11. The electrochemical apparatus according to claim 14, wherein the coating comprises a polymer, and the polymer comprises at least one of the following compounds: polytetrafluoroethylene, polyvinylidene fluoride, a tetrafluoroethylene-perfluorinated alkyl vinyl ether copolymer, an ethylene-tetrafluoroethylene copolymer, an ethylene-chlorotrifluoroethylene copolymer, perfluorinated ethylene-propylene copolymer, acrylic acid, methacrylic acid, itaconic acid, ethyl acrylate, butyl acrylate, acrylonitrile, or methacrylonitrile.

12. The electrochemical apparatus according to claim 14, wherein the coating comprises inorganic particles, and the inorganic particles comprise at least one of the following compounds: aluminum oxide, silicon dioxide, magnesium oxide, titanium oxide, hafnium dioxide, tin oxide, ceria oxide, nickel oxide, zinc oxide, calcium oxide, zirconium oxide, yttrium oxide, silicon carbide, boehmite, aluminum hydroxide, magnesium hydroxide, calcium hydroxide, or barium sulfate.

13. An electronic apparatus, comprising an electrochemical apparatus, the electrochemical apparatus, comprising a positive electrode, a negative electrode, a separator and an electrolyte, the electrolyte comprising a compound of formula I: 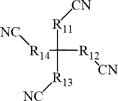
wherein R₁₁ is selected from a covalent bond, a substituted or unsubstituted C₁-C₂₀ alkylidene group, a substituted or unsubstituted C₂-C₂₀ alkenylene group, a substituted or unsubstituted C₂-C₂₀ alkynylene group, a substituted or unsubstituted C₆-C₂₀ arylene group, a substituted or unsubstituted C₃-C₂₀ heteroarylene group, a substituted or unsubstituted C₃-C₂₀ cycloalkylene group, 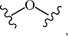 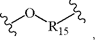 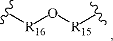
or a combination thereof;
wherein R₁₂, R₁₃, and R₁₄ are each independently selected from a substituted or unsubstituted C₁-C₂₀ alkylidene group, a substituted or unsubstituted C₂-C₂₀ alkenylene group, a substituted or unsubstituted C₂-C₂₀ alkynylene group, a substituted or unsubstituted C₆-C₂₀ arylene group, a substituted or unsubstituted C₃-C₂₀ heteroarylene group, a substituted or unsubstituted C₃-C₂₀ cycloalkylene group, 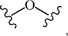 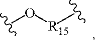 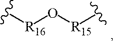
or a combination thereof;
wherein R₁₅ and R₁₆ are each independently selected from a C₁-C₂₀ alkylidene group, a substituted or unsubstituted C₂-C₂₀ alkenylene group, a substituted or unsubstituted C₂-C₂₀ alkynylene group, a substituted or unsubstituted C₆-C₂₀ arylene group, a substituted or unsubstituted C₃-C₂₀ heteroarylene group, or a substituted or unsubstituted C₃-C₂₀ cycloalkylene group;
wherein when the groups are substituted, substituents each are selected from halogen, a C₁-C₂₀ alkyl group, a C₃-C₂₀ cycloalkyl group, a C₂-C₂₀ alkenyl group, a C₆-C₂₀ aryl group, or a C₃-C₂₀ heteroaryl group, and
wherein the heteroatom is selected from one or more of O, S, N, and P.

14. The electrochemical apparatus according to claim 8, wherein the compound of formula I comprises at least one of the following compounds: 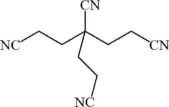 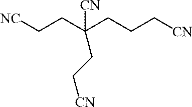 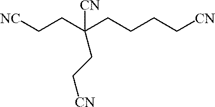 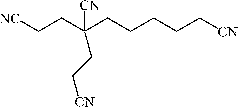 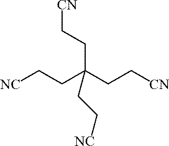 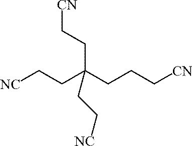 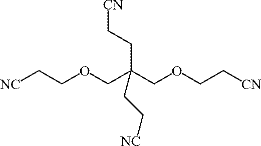 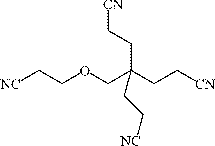 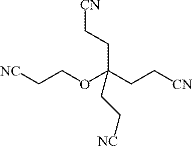 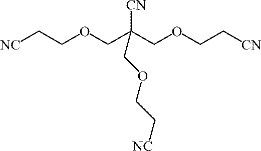 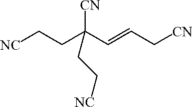 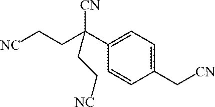 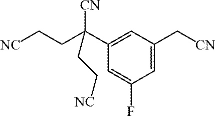 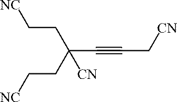 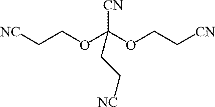 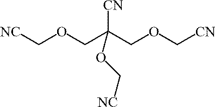
or 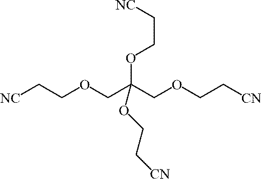
.

15. The electrochemical apparatus according to claim 8, wherein based on a total weight of the electrolyte, a content of the compound of formula I is 0.01 wt% to 5 wt%.

16. The electrochemical apparatus according to claim 8, further comprising a compound containing sulfur-oxygen double bonds, and the compound containing sulfur-oxygen double bonds comprises at least one of the following compounds: 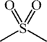 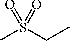 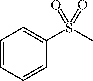 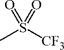 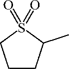 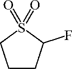 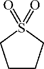 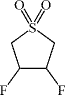 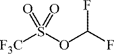 [SMILES: O=S(=O)(OC(F)F)C(F)(F)F] 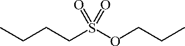 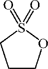 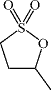 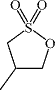 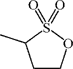 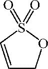 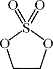 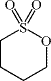 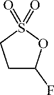 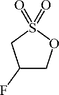 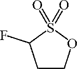
or 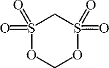
.

17. The electrochemical apparatus according to claim 11, wherein based on the total weight of the electrolyte, a content of the compound containing sulfur-oxygen double bonds is 0.01 wt% to 10 wt%.

18. The electronic apparatus according to claim 16, wherein based on a total weight of the electrolyte, a content of the compound of formula I is 0.01 wt% to 5 wt%.
